(19) United States
(12) Patent Application Publication
(10) Pub. No.: US 2018/0087763 A1
(43) Pub. Date: Mar. 29, 2018

(54) Lighting Systems, Methods and Components

(71) Applicant: Efficiency Matrix Pty Ltd, Wheelers Hill, Melbourne (AU)

(72) Inventor: John Konstantakopoulos, Wheelers Hill, Melbourne (AU)

(21) Appl. No.: 15/564,028

(22) PCT Filed: Apr. 3, 2016
(86) PCT No.: PCT/AU2016/050251

§ 371 Date: Oct. 3, 2017

(30) Foreign Application Priority Data
Apr. 3, 2015 (AU) 2015901224
Dec. 7, 2015 (AU) 2015905067

(51) Int. Cl. F21V 29/70; F21S 8/02; F21V 29/89; F21V 3/00; F21V 23/06; F21V 23/02; F21V 17/10

(52) U.S. Cl. CPC F21V 29/70; F21S 8/026; F21V 29/89; F21Y 2115/10; F21V 23/06; F21V 23/02; F21V 17/101; F21V 3/00

(57) ABSTRACT

In one preferred form of the present invention, there is provided a down-light system component (10) comprising: a portion (12) that is made from relatively high heat-conductivity material. The portion (12) is provided for conducting heat away from a light source (14) to a position on or underneath plasterboard or other ceiling material. The portion (14) is configured to dissipate heat in a manner maintaining a desirable operative temperature of the light source (14), to increase the lifetime of the light source.

### INCORPORATION BY REFERENCE

Priority is claimed from: (i) Australian Application 2015905067 entitled “LIGHTING SYSTEMS, METHODS AND COMPONENTS” filed 7 Dec. 2015; and (ii) Australian application 2015901224 entitled “LIGHTING SYSTEMS, METHODS AND COMPONENTS” filed 3 Apr. 2015. All parts and elements of these two applications are hereby fully incorporated by reference for all purposes.

### FIELD OF THE INVENTION

In particular forms, the present invention relates to lighting systems, methods and components.

### BACKGROUND To THE INVENTION

Roof spaces may include down-light covers, insulation and cabling. Lighting systems installed in roof spaces may present a fire risk. The longevity of lighting systems and components, in particular LED lighting elements, can depend on a number of factors including the operating temperature of the lighting element.

Whilst the present invention is particularly concerned with LED lighting systems, the Applicant considers that the present invention may find application in other lighting systems.

It would be advantageous to provide improved the LED-type systems and components, or at least provide the public with a useful choice. It is against this background that the present invention has been developed by the inventor.

### SUMMARY OF THE INVENTION

According to a first aspect of preferred embodiments herein described there is provided a down-light system component comprising: a portion that is made from relatively high heat-conductivity material; the portion for conducting heat away from a light source to a position on or underneath plasterboard or other ceiling material; the portion being configured to dissipate heat in a manner maintaining a desirable operative temperature of the light source.

Preferably the portion is for conducting heat to a position on the plasterboard or other ceiling material, above a room area, to cause the plasterboard or other ceiling material to act as a heat sink for transmission into the room area below.

Preferably the surface area of the portion is at least 30 cm̂2.

Preferably the material comprises predominantly copper, graphite or aluminium material and the surface area is at least 40 cm̂2.

Preferably the surface area of the portion is at least 20 cm̂2.

Preferably the relatively high heat-conductivity material comprises metal material.

Preferably the material comprises copper, graphite or aluminium material.

Preferably the material comprises predominantly copper, graphite or aluminium material to provide relatively high heat conductivity.

Preferably the surface area is between 30 to 50cm̂2.

Preferably the surface area is sized for a LED-type light having a power consumption of at least 40 Watts.

Preferably the surface area is sized for a LED-type light having a power consumption of between 40 to 55 Watts.

Preferably the downlight system component includes at least one elongate planar portion having a relatively large planar face for contacting and extending above the plasterboard or other ceiling material away from the light fitting along the plasterboard or other ceiling material.

Preferably the or each at least one planar portion is able to be inserted through a hole sized for receiving a downlight of the downlight system, enabling the downlight system component to be installed from below the plasterboard or other ceiling material.

Preferably the downlight system component includes head portion and a flexible wrapping portion, both of relatively high heat conductivity; the flexible tether having one end for being wrapped around the body of a lighting element and extending to the head portion for transmitting heat thereto, the head portion for contacting the plasterboard or other ceiling material.

Preferably the downlight component includes at least one planar element connected to a rim surrounding the face of the lighting element; the or each planar element having a surface area of at least 15 cm̂2; the or each planar element and being moveable between an upright condition and a substantially horizontal condition for contacting and extending above the plasterboard or other ceiling material.

Preferably the portion comprises a base portion for contacting the plasterboard or other ceiling material from above and transmitting heat thereto; and an extension portion for extending around an upper end of the a lighting element and conducting heat away from the lighting element to the base portion.

Preferably the extension portion comprises a flexible tether having two ends in the vicinity of the plasterboard or other ceiling material; the flexible tether for extending over the rear of the lighting element to the other end.

Preferably the extension portion further includes a relatively high heat conductivity cover for receiving the lighting element.

Preferably the extension portion is cone-shaped for fitting into a downlight cover.

Preferably the extension portion includes a slit along its length on one side for allowing cabling to access the light element.

According to a second aspect of preferred embodiment herein described there is provided a down-light system component including a portion that is made from relatively high heat-conductivity material; the portion for facing into a room area below plasterboard or other ceiling material to dissipate heat into the room area in a manner maintaining a desirable operative temperature due to the relatively high heat conductivity of the portion and surface areal the portion being configured to transmit heat away from a lighting element.

Preferably the portion provides a room facing area of at least 30 cm̂2 for a lighting element of at least 40 Watts.

Preferably the portion comprises a room facing area of at least 50 cm̂2 for a lighting element of at least 40 Watts.

According to another aspect of preferred embodiments herein described there is provided a down-light system component comprising: a portion that is made from relatively high heat-conductivity material; the portion for contacting plasterboard or other ceiling material to dissipate heat in a manner maintaining a desirable operative light element temperature due to the relatively high heat conductivity of the portion and surface area transmitting heat into the plasterboard or other ceiling material for transmission into the room area below.

According to another aspect of preferred embodiments herein described there is provided a method of controlling the elevated temperature of a downlight or transformer comprising proactively transmitting heat away from a lighting element of the downlight or transformer by providing a portion that is made from relatively high heat-conductivity material; the portion for contacting plasterboard or other ceiling material to dissipate heat in a manner maintaining a desirable operative temperature due to the relatively high heat conductivity of the portion and surface area transmitting heat into the room area below.

According to another aspect of preferred embodiments herein described there is provided a down-light system component including: a first portion made from relatively high heat-conductivity material, the first portion able to extend around the body of a downlight; and a second portion made from relatively high heat conductivity material, the second portion for contacting the top of the downlight; the first portion and the second portion being configured to conduct heat away from the downlight to a heat sink in a manner maintaining a desirable operative temperature.

Preferably the first portion comprises two extending portions configured to be secured together in a manner where each extending portion extends around the body of the downlight.

Preferably the second portion comprises an element having an end adapted to be connected to the top of the downlight to conduct more heat away from the downlight than with the first portion alone. Preferably the end of the second portion is adapted to be glued to the top of the downlight using a conductive glue.

Preferably the second portion is longer than each extending portion of the first potion.

Each extending portion may comprise an arm that is about 70 mm in length. The second portion may be 80 mm in length. The second portion and each extending arm may extend from a connecting element.

Preferably there is provided a third portion of heat conductive material from which the first portion and the second portion extend, the third portion comprising a length configured to be connected to a heat sink.

According to another aspect of preferred embodiments herein described there is provided a downlight system component comprising: a length of heat conductive material having a first end for a downlight and a second end for a heat sink; the first end comprising at least one portion for extending around the body of a downlight; and a further portion for contacting the top of the downlight; the first end for conducting heat away from the downlight to the heat sink in a manner maintaining a desirable operative temperature of the downlight.

Preferably the at least one portion for extending around the body of the downlight comprises two arms having respective ends that are configured to be connected together using a connecting element.

Preferably the connecting element comprises a cord.

Preferably the connecting element comprises a temperature rated string.

Preferably the connecting element comprises temperature rated string; and the respective ends of the two arms each include a hole for receiving the string; the string being able to be secured between the holes to hold the two arms in positon extending around the downlight.

Preferably a releasable clasp is used to hold the string in position and therefore the two arms extending around the downlight. Preferably the clasp includes a hole through which the ends of the string extend and a button that is operable to release a clamp that clamps the string within the hole of the clasp.

Preferably the further portion for contacting the top of the downlight comprises a tab configured to be glued to the top of the downlight. Preferable the further portion is glued using a conductive glue.

Preferably IC and IC-F rated fittings are provided in preferred embodiments. LED lighting systems are provided in preferred embodiments including OLED lighting systems.

Preferably a 10 to 15 degree temperature drop is provided when under insulation, compared to when the arrangement is not employed.

Preferably a 15 to 20 degree temperature drop is provided when under insulation, compared to when the arrangement is not employed.

Preferably more than a 15 degree temperature drop is provided when under insulation, compared to when the arrangement is not employed.

According to another aspect of preferred embodiments herein described there is provided a mount for assisting with controlling the elevated temperature of a transformer; the mount including a biasing portion for forcing the transformer towards plasterboard or other ceiling material; the biasing portion assisting with transmitting heat away from the transformer by ensuring contact with the plasterboard or other ceiling material.

Preferably the mount is formed from spring steel.

Preferably the mount includes a portion for fixing the mount to a roof element.

According to another aspect of preferred embodiments herein described there is provided a method for assisting with controlling the elevated temperature of transformer; the method including forcing the transformer toward plasterboard or other ceiling material; the biasing assisting with transmitting heat away from the transformer by ensuring contact.

It is to be recognised that other aspects, preferred forms and advantages of the present invention will be apparent from the present specification including the detailed description, drawings and claims.

### BRIEF DESCRIPTION OF DRAWINGS

In order to facilitate a better understanding of the present invention, several preferred embodiments will now be described with reference to the accompanying drawings, in which:

FIG. 1 provides a perspective view of a light fitting according to a preferred embodiment of the present invention.

FIG. 2 provides a perspective view of the light fitting of FIG. 1 installed in the operative condition.

FIG. 3 provides a side schematic view of a conventional IC fitting both abutted with insulation on its sides and covered with insulation material from above.

FIG. 4 provides a side schematic view illustrating heat dissipation in a conventional IC/IC-F lighting component having a down-light cover.

FIG. 5 provides a side schematic view showing heat build-up in a confined area.

FIG. 6 provides a side schematic view showing heat build-up in a confined area with a lighting element having a down-light cover.

FIG. 7 provides a perspective view of a down light system component according to another preferred embodiment of the present invention.

FIG. 8 provides a further view of the downlight system component shown in FIG. 7.

FIG. 9 provides a perspective view of a down light system component for being abutted against a downlight, the component according to another preferred embodiment of the present invention.

FIG. 10 provides a perspective view a down light system component according to another preferred embodiment of the present invention.

FIG. 11 provides a further view of the downlight system component shown in FIG. 10.

FIG. 12a provides a side schematic view of a further preferred embodiment of the present invention.

FIG. 12b provides a view of a conducting element used in the downlight system shown in FIG. 12a.

FIG. 13 provides a perspective view of a down light system component according to another preferred embodiment of the present invention.

FIG. 14 provides a perspective view a down light system component according to another preferred embodiment of the present invention.

FIGS. 15a and 15b provide perspective views of a light fitting according to a preferred embodiment of the present invention.

FIG. 16 illustrates a method according to a preferred embodiment of the present invention.

FIGS. 17a and 17b provide perspective views of a down light system component according to another preferred embodiment of the present invention.

FIG. 18 provides schematic view of the downlight system component shown in FIGS. 17a and 17b.

FIG. 19 provides a schematic view of a transformer according to an embodiment of the present invention.

FIGS. 20 and 21 provide views of further embodiments the present invention.

FIGS. 22a to 22b illustrate a further preferred embodiment of the present invention.

FIGS. 23a and 23b provide a thermal lifetime report detailing possible lifetime modelling, acceleration factors and other calculations.

FIGS. 24a to 24f provides a temperature report illustrating a possible cooling effect of preferred embodiments of the present intention.

FIGS. 25 to 31 illustrate further preferred embodiments of the present invention.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

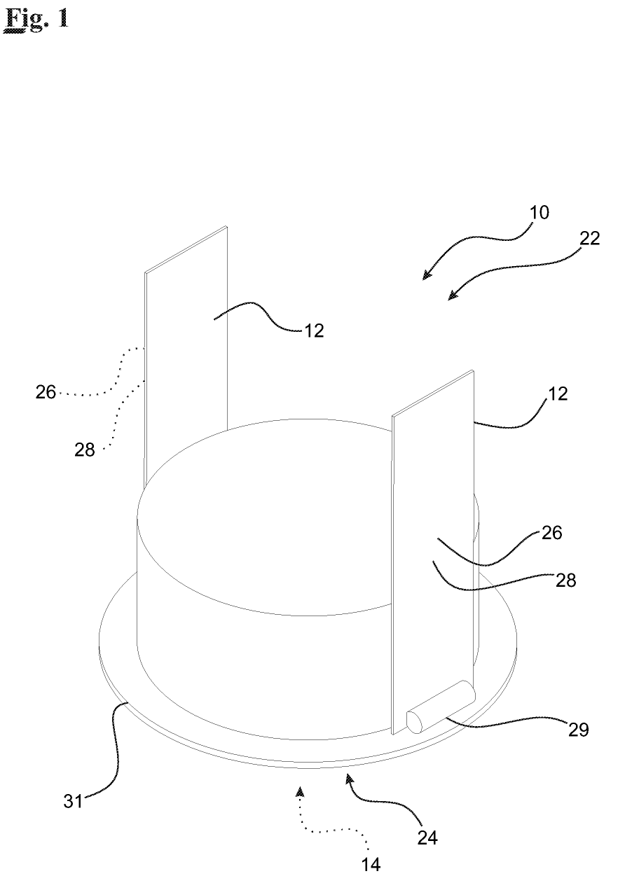

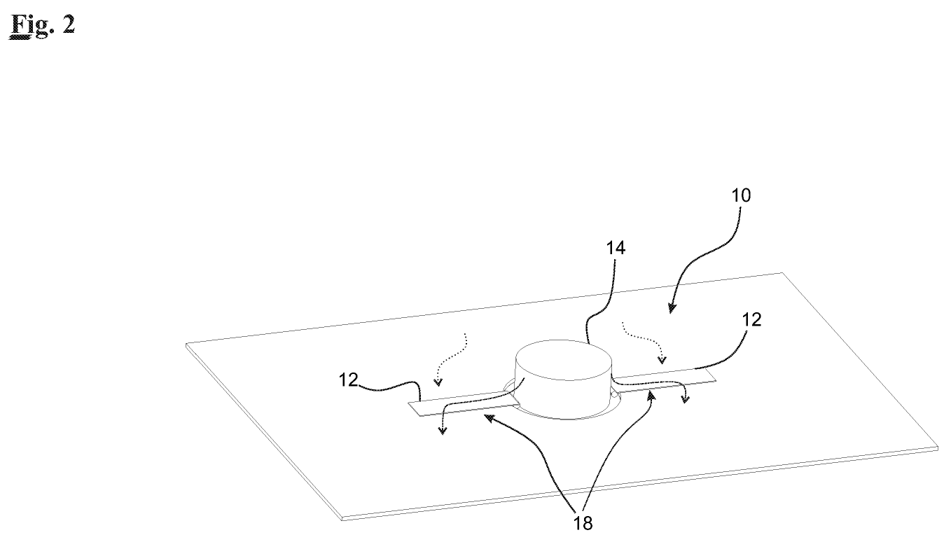

Referring to FIGS. 1 and 2 there is provided a downlight system component 10 according to a first preferred embodiment of the present invention. The downlight system component 10 comprises two portions 12 that are each made from relatively high heat-conductivity material (copper or aluminium). The portions 12 are provided for conducting heat away from a light source 14 to a position on plasterboard or other ceiling material 16 as shown in FIG. 2. The plasterboard 16 acts as a heat sink. As a result of the arrangement, the portions 12 are configured to dissipate heat in a manner maintaining a desirable operative temperature of the light source 14.

The two portion 12 together provide a combined portion 18 having a total lower surface area 20 of 30 cm̂2 for bearing against the plasterboard 16. The downlight system component 10 is provided as an LED lighting component 22 having an LED light source 24.

Notably, plasterboard has a relatively poor R-value (say 0.05). As a result radiating heat through it with a conductive material can be quite effective, when insulation has been installed above. Thus with the provision of the portions 12, the component 10 serves to advantageously maintain a lower light source temperature and therefore to increase the life of the LED lighting source 24. It is considered that the life of the lighting component can be extended by say 10 to X % or more. Greater increases could be possible due to the reduction in temperature.

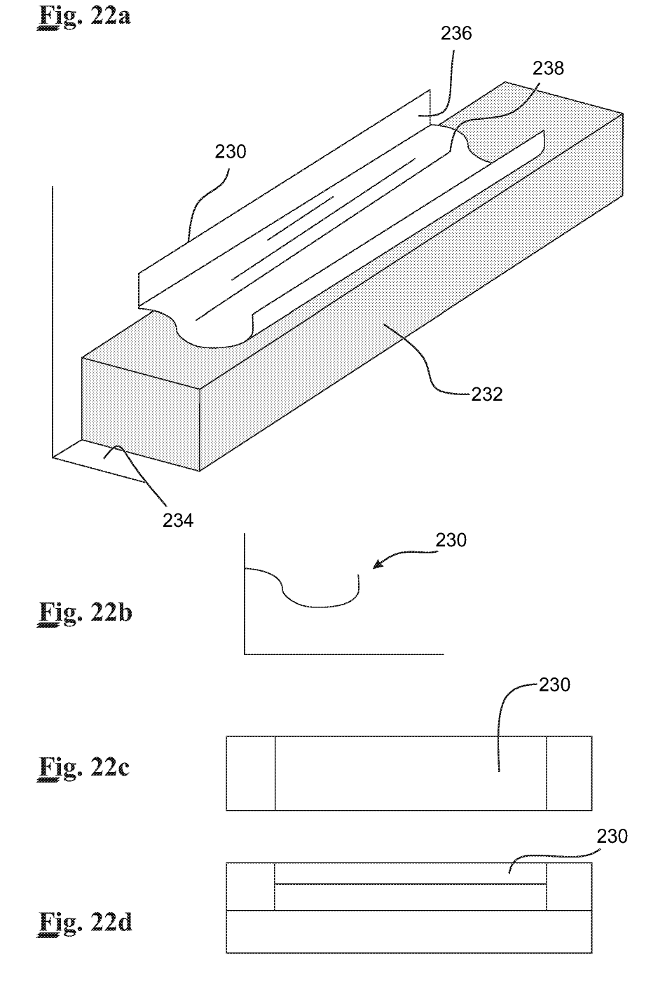

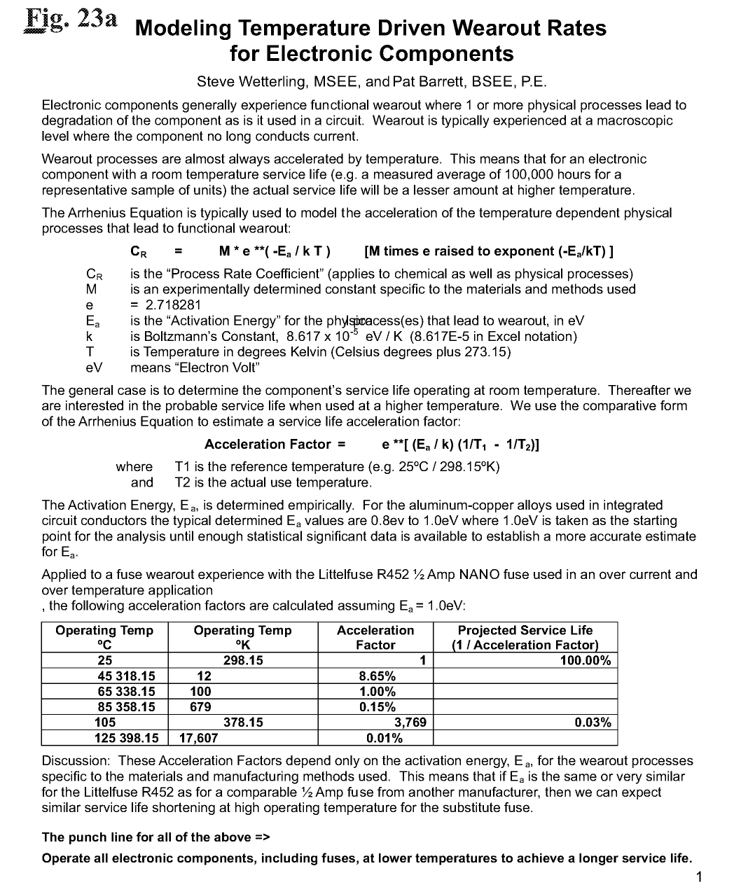

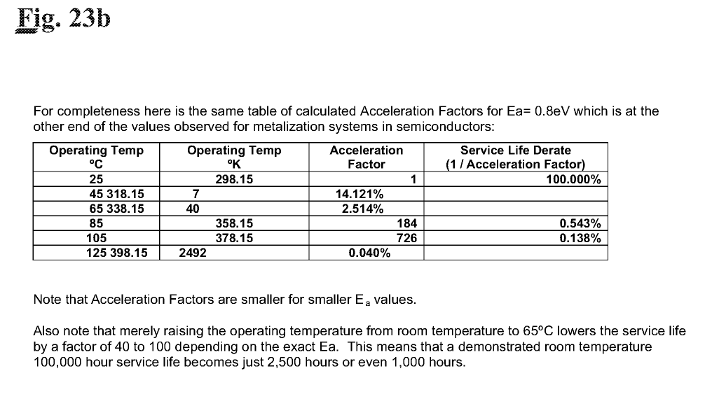

The article ‘Modeling Temperature Driven Wearout Rates For Electronic Components’ (Steve Wetterling, MSEE, and Pat Barrett, B SEE, P.E) considers the lifetime of a Littelfuse R452 ½ Amp NANO fuse' with respect to current and temperature. The following acceleration factors were calculated in the article assuming Eₐ=1.0 eV. This produced the following lifetime table. A copy of the document is provides in FIGS. 21a and 22b for completeness.

| | | | Projected Service |
|---|---|---|---|
| Operating | Operating Temp | Acceleration | Life (1/Acceleration |
| Temp ° C. | ° K | Factor | Factor) |
| 25 | 298.15 | 1 | 100.00% |
| 45 | 318.15 | 12 | 8.65% |
| 65 | 338.15 | 100 | 1.00% |
| 85 | 358.15 | 679 | 0.15% |
| 105 | 378.15 | 3,769 | 0.03% |
| 125 | 398.15 | 17,607 | 0.01% |

The Applicant considers that the article shows potential temperature lifetime effects. Nonetheless, it is noted that increases in lifetime are yet to be fully investigated by the Applicant. The Applicant is not making any claims regarding the extent of lifetime increase. The lighting component 22 may also be used for purposes of reducing fire risk. The Applicant is not making any claims regarding fire risk reduction.

Returning to FIG. 1, each of the two portions 12 is provided as an elongate planar portion 26 having a relatively large planar face 28 for contacting and extending above the plasterboard as shown in FIG. 2. The two portions 12 are hinged attached to the body of the lighting component 22 using a spring arrangement 29.

Advantageously the two portions 12 have a thermal conductivity of more than 150 (W·m−1·K−1). Other embodiments may have a thermal conductivity of more than 200 (W·m−1·K−1). Both Aluminium and Copper are considered suitable in increasing the lifetime of the LED light source 24. In the embodiment the lighting element has a diameter of about 90 mm and the projections are each about 8 cm in length (about 2 cm wide). Other lengths and widths are of course possible. Other materials that could be used include graphite.

The planar elements 12 are connected to a rim 31 surrounding the face of the lighting component 22. E planar element has a surface area of 15 cm̂2 and is moveable between an upright condition (see FIG. 1) and a substantially horizontal condition (See FIG. 2) for contacting and extending above the plasterboard 16.

Advantageously in this embodiment, the lighting component 22 is able to be inserted through a hole sized for receiving the downlight component. That is a hole about 90 mm in diameter. The lighting component 22 may be provided in other dimensions such as 70 mm or 120− to 150 mm+. The lighting component 22 forms a downlight.

Advantageously the portions 12 are moveable between an upwardly extending condition 30 and a horizontally extending condition 32. The horizontally extending condition 32 provides both a ‘holding function’ and a heat to plasterboard ‘conductivity function’. The conductivity function is considered to be new and inventive in terms of the portions 12 receiving heat energy by way of conduction and radiation and conducting the heat energy to the plasterboard 16. The plasterboard 16 acts as a heat sink for transmission into the room area below.

Room areas are generally much cooler than ceiling areas. The presence of the room area will serve to cool the plasterboard 16 and assist with providing the advantages discussed.

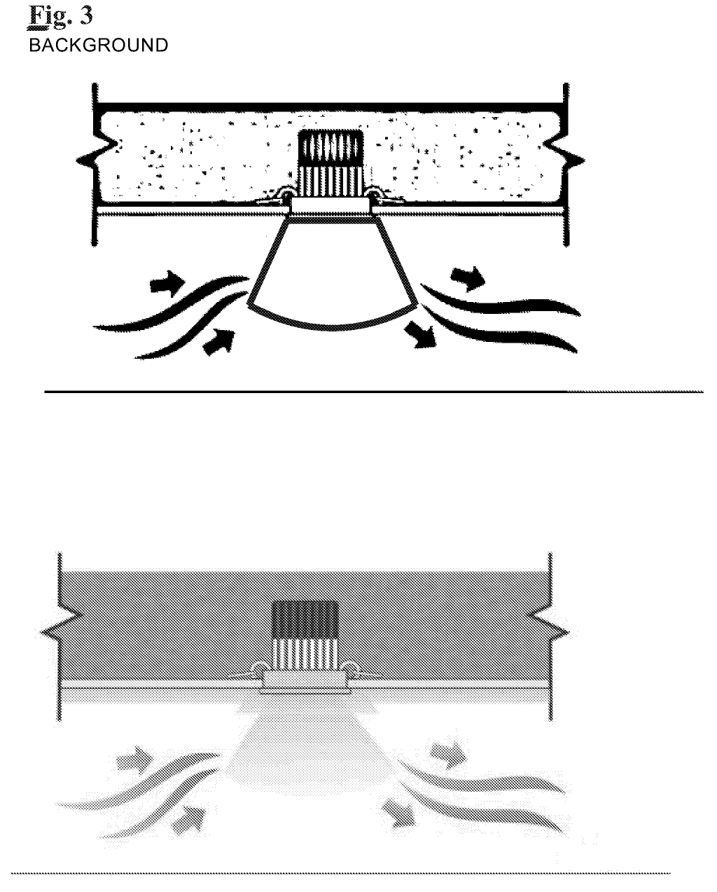

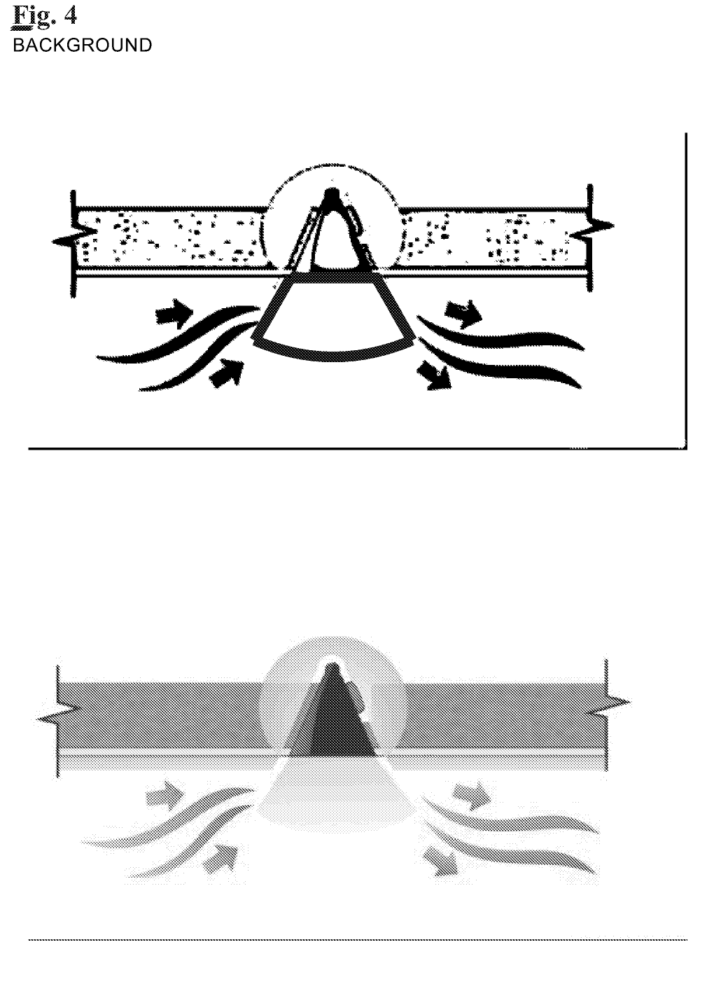

IC and IC-F rated fittings can be both abutted and covered with insulation. This is shown in FIG. 3. In the case of a CA90 downlight fitting, the fitting can be abutted to only by its sides to the insulation. FIG. 4 illustrates a cover serving to extend the building envelope and protect a light source.

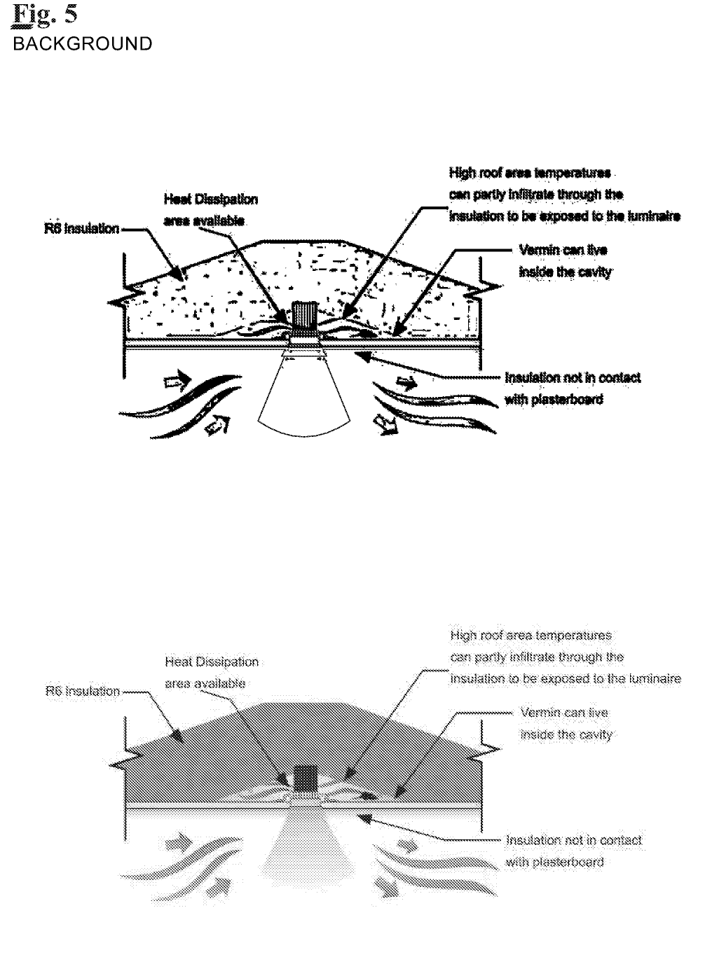

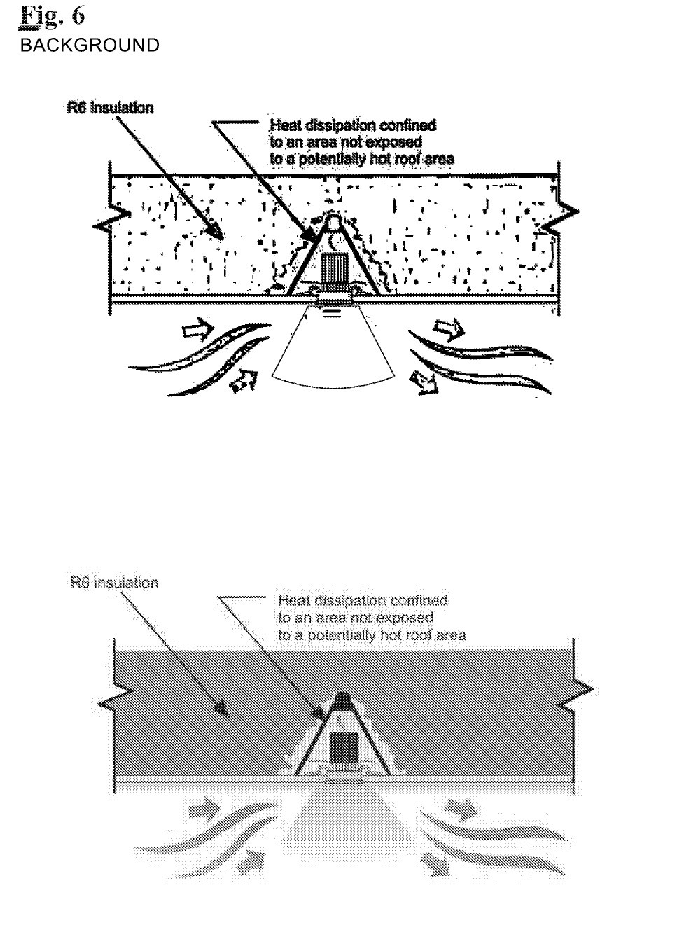

As shown in FIGS. 5, without a downlight cover high roof temperatures can penetrate though the insulation to the light source (luminaire). Nonetheless, as shown in FIG. 6, even with a downlight cover heat build-up can occur inside the cover as the downlight cover still maintains a relatively high temperature. It is to be appreciated that the present embodiment could be applied both with and without a downlight cover.

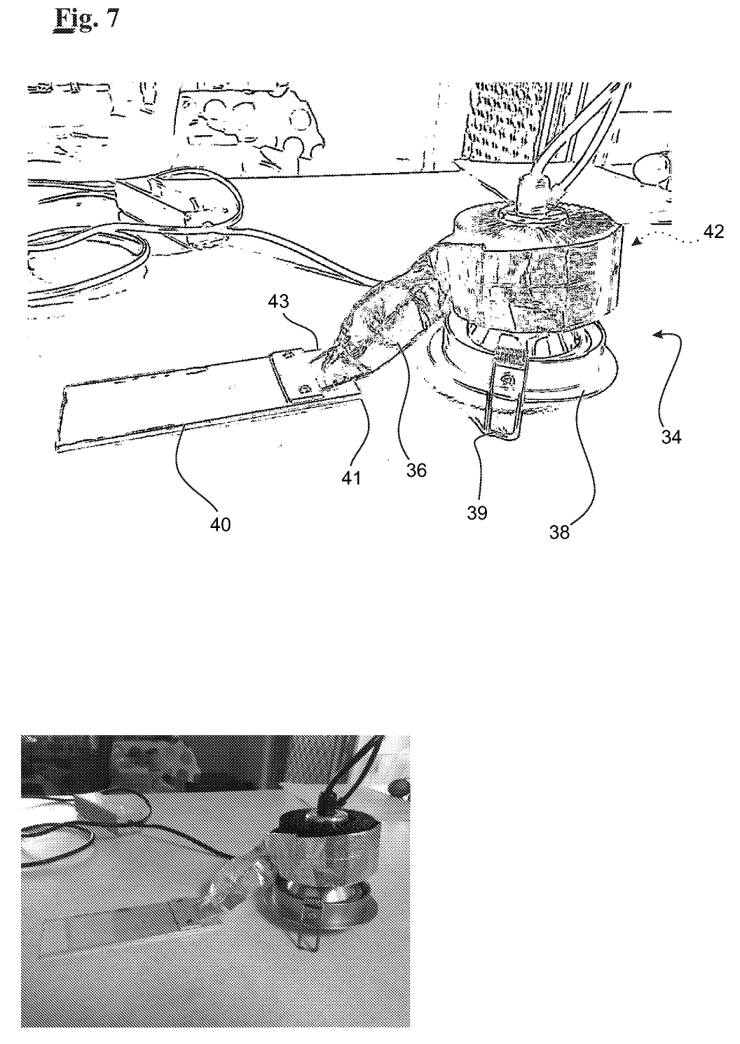

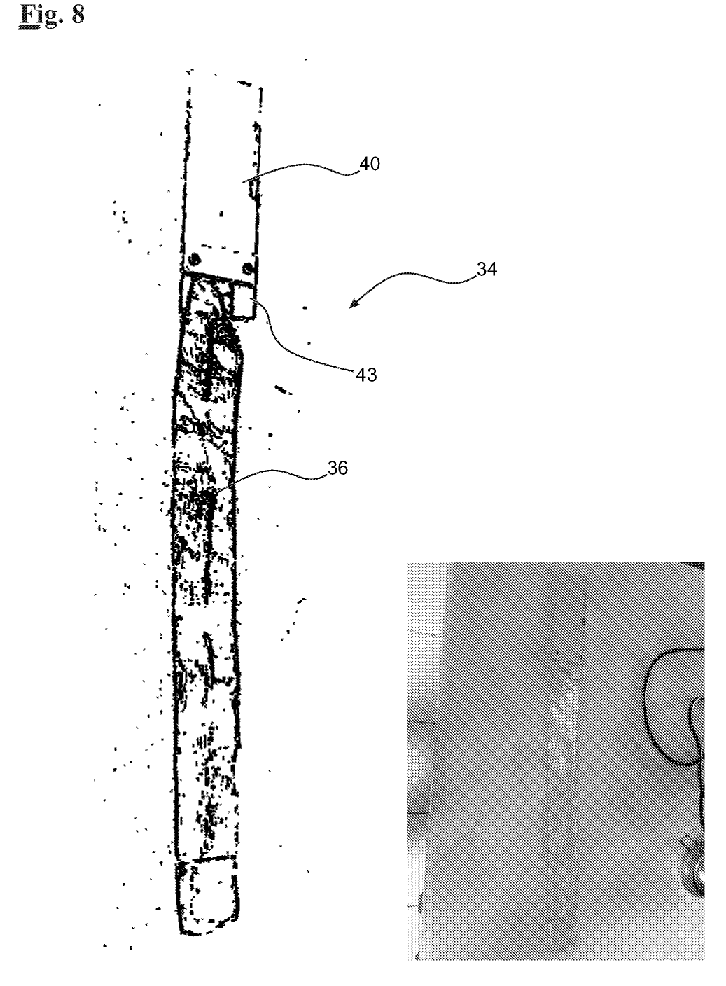

Referring to FIGS. 7 and 8 there is shown a down-light system component 34 according to a further embodiment of the present invention. The down-light system component 34 includes a flexible wrapping portion 36 that is wrapped around the body of a light source 38.

The component 34 includes a planar head portion 40 connected to the flexible wrapping portion 36. The flexible wrapping portion 36 is formed from high heat conductivity aluminium material. The head portion 40 is formed also formed for aluminium material but is solid in construction. The head portion 40 provides a planer smooth lower surface for transmitting heat to plasterboard.

The flexible wrapping portion 36 provides one end 42 for being wrapped around the body of the lighting element 38 and extends to the head portion 40 for transmitting heat thereto. The head portion 40 is provided for contacting the plasterboard or other ceiling material. Advantageously the flexible wrapping portion 36 is able to be wrapped around existing light sources allowing for retrofits of existing downlights.

The wrapping portion 36 provides a conductive flexible material (in a cable tie type of solution), that could be coated with a thin plastic to make it nonconductive, but still allow thermal transfer of heat to a shard that would sit on top of plaster underneath insulation. An addition Velcro or cable tie fixing method could be applied.

The downlight system component 34 is able to be inserted through a conventional hole in the plasterboard for the downlight 38 from below. When the flexible portion 36 is wrapped around the body of the lighting element 38, the head portion 40 is able to be inserted into the roof cavity. This occurs before insertion of the downlight. Advantageously the standard LED clip 39 can be used to hold the head in position. The flexible wrapping portion 36 is connected at a location spaced away from the end 41 of the head portion to provide an abutment 43 for the clip 39.

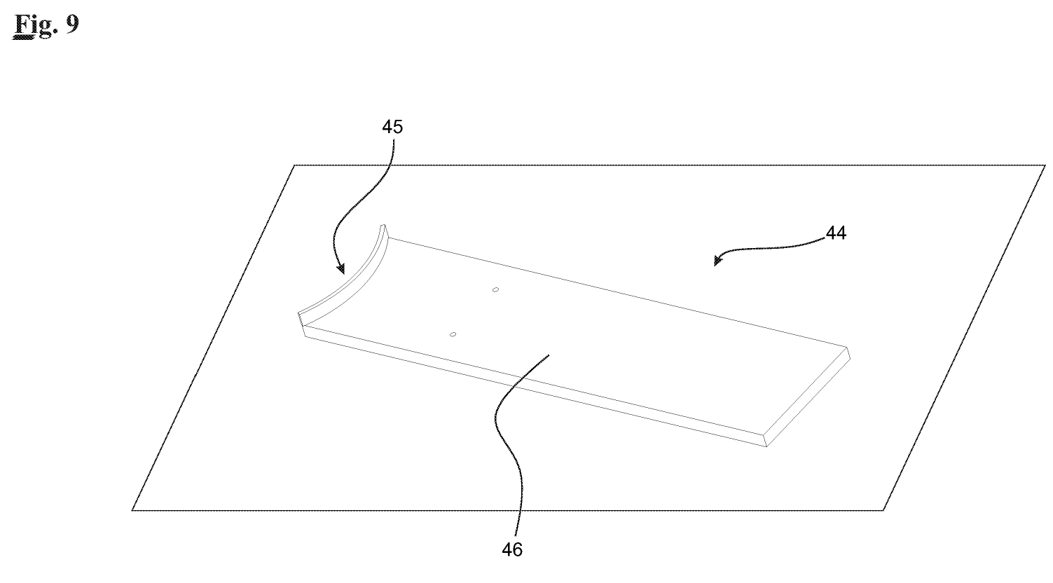

Referring to FIG. 9 there is shown a downlight system component 44 according to a further preferred embodiment of the present invention. The downlight system component 44 is provided in the form of an elongate shard 46 having a concave inwardly end 45 that is placed against or next to an LED downlight light source. Preferably a magnetic connection is made between the LED downlight and the component 44. In this embodiment the end 45 is magnetised for being attracted to the LED downlight. The shard 46 could also contact a conductive cover surrounding the LED downlight.

In other embodiments it is possible that a mating thermally conductive point is designed on the luminaire as well for the attachment of a shard. A specific flat surface could use a thermally conductive clag.

The shard 46 provides conduit that receives heat energy either by radiation or conduction from the light source and transmits the heat energy to the plasterboard. The shard 46 operates without the flexible wrapping portion 36.

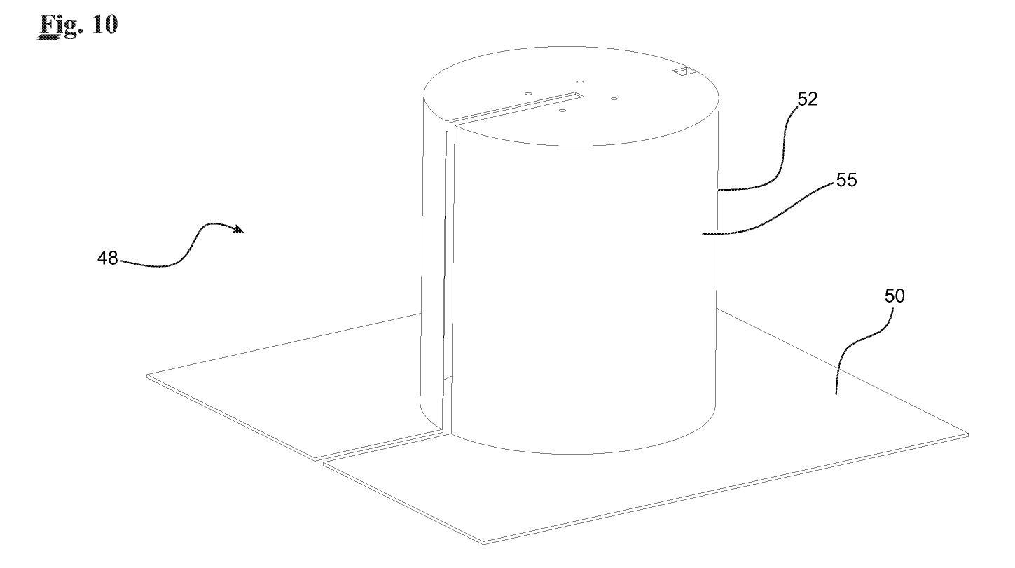

Referring to FIGS. 10 and 11 there is shown a downlight system component 48 according to yet another preferred embodiment of the present invention. The component 48 comprises a base portion 50 for contacting plasterboard or other ceiling material from above and transmitting heat thereto. The component 48 further includes an extension portion 52 for extending around an upper end of a lighting element and conducting heat away from the lighting element to the base portion. In this embodiment the extension portion 52 provides a split cover 55. The split is provided by a slot 54 that extends along the extension portion 50 to allow for readily access by cabling. There are holes at the top for possibly fixing an internal metal conductive strap for installing downlight covers which provide a fire rating and sound proofing.

The extension portion 52 is arranged to absorb heat radiation and transmit the heat energy to the base portion 50. The base portion 50 is arranged to transmit the heat energy to the plasterboard. The base portion 50 and the extension portion 52 are formed from relatively high heat conductivity material (aluminium or copper)

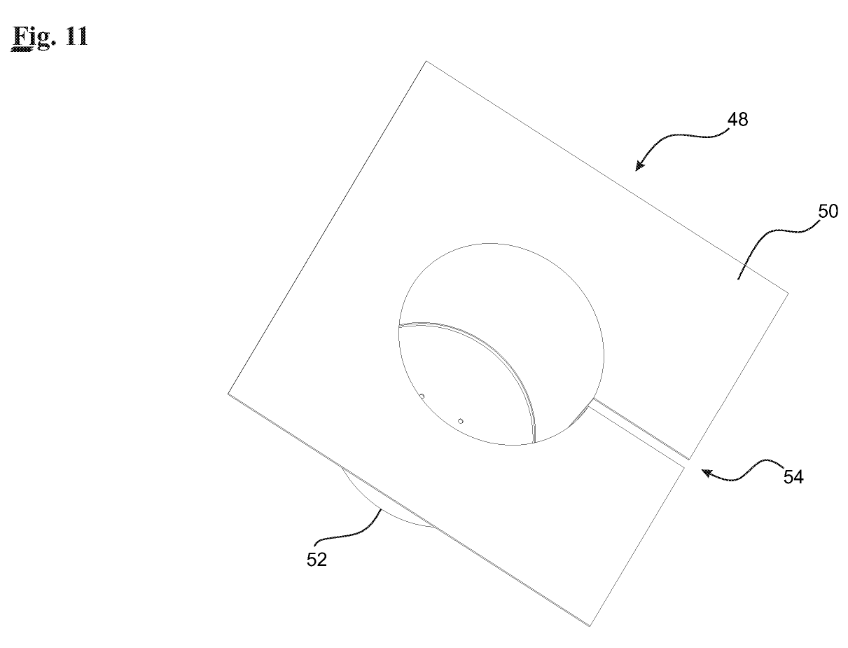

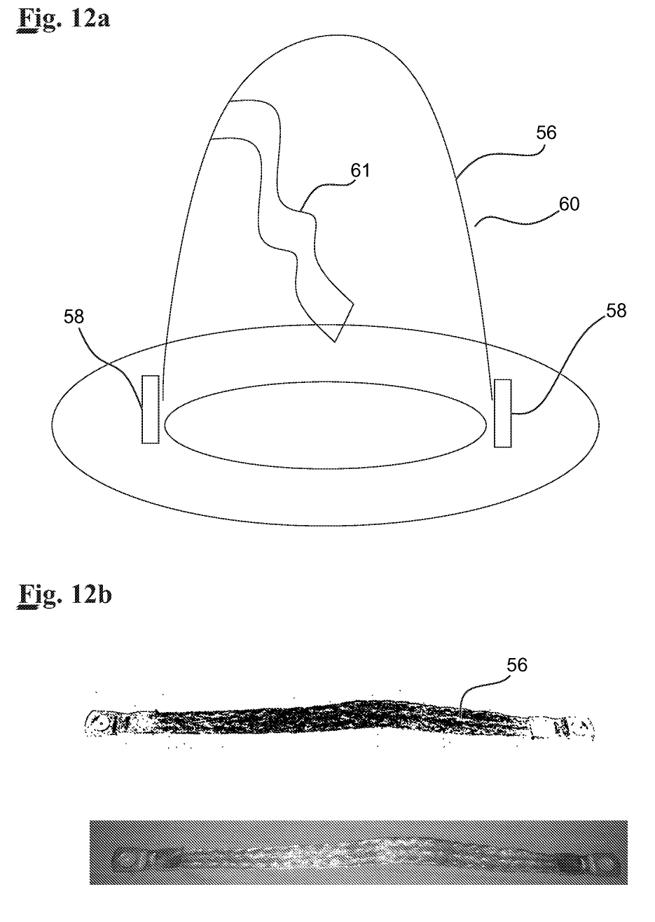

Referring to FIGS. 12a and 12b, there is show a further preferred embodiment that makes uses of an element 56 for remote or direct contact with the back of the downlight. The flexible element 56 extends from two points 58 in the vicinity of the base portion 50 to provide a loop 60 for conducting heat energy. A conducting foil wrapping 61 could also be used to make direct contact with the element 56 and the light source. In other embodiments the element 56 may bear directly on a heat sink that sits on top of the LED

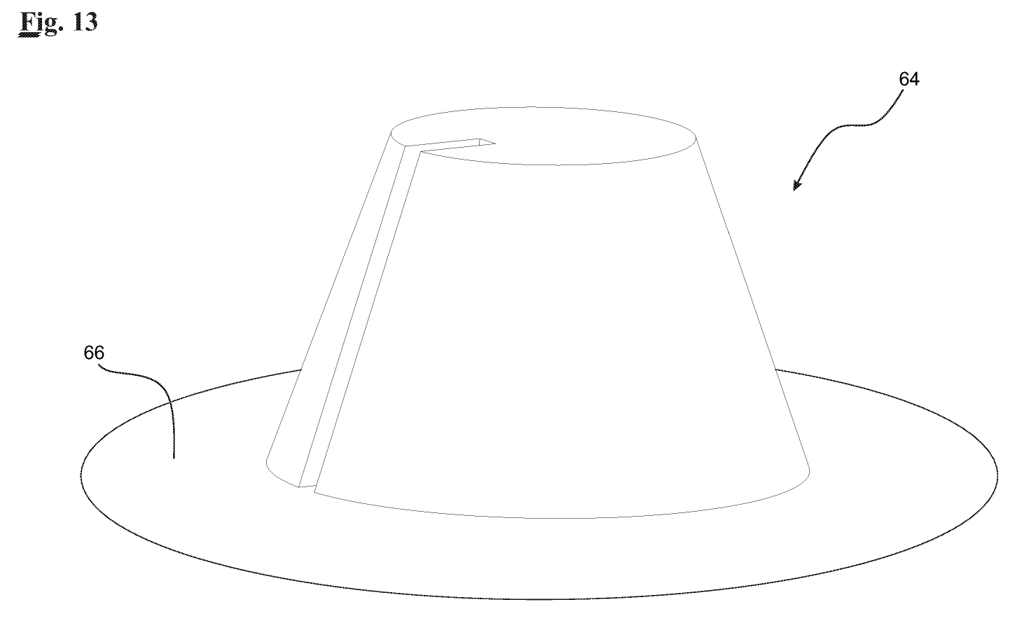

Referring to FIG. 13, there is shown a further component 64 according to a preferred embodiment of the present invention. In the component 64 the extension 52 is frusto-concially shaped for receiving a down light cover. Other embodiment may be conically shaped.

Such an arrangement advantageously combines the benefit of downlight covers in combination with a relatively high heat conductivity body for transmitting heat to the plasterboard. As discussed the plasterboard acts as a heat sink in combination with the room below.

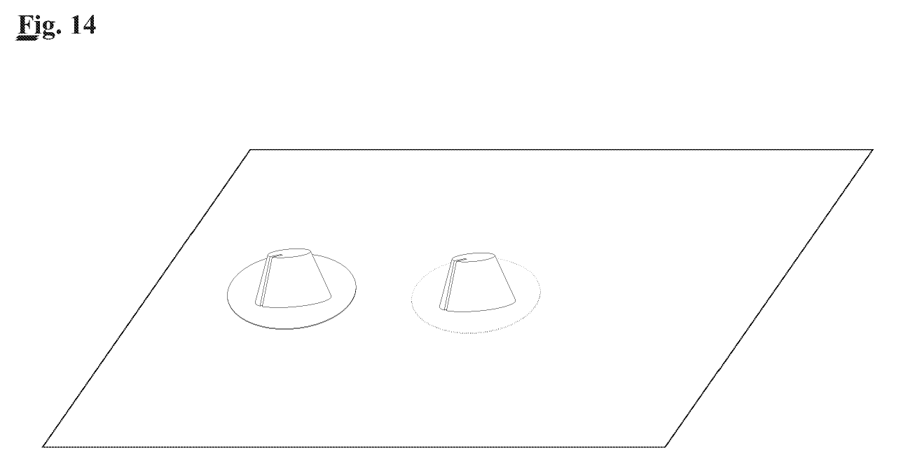

The component 64 can be placed on the plasterboard from above or be located below the plasterboard as shown in FIG. 14. In the case of being located below the plasterboard the rim 66 is in direct facing contact with a room area air. The room itself is able to provide cooling. Thus contact with the plasterboard for transmission of heat energy may not be required in some embodiments. The lower surface area of the rim that faces the room is preferably more than 30 cm̂2. The rim is preferably also fixed to the plasterboard. Various fixing arrangements are possible including clips

Thus portion 66 is provided for facing into a room area below plasterboard or other ceiling material to dissipate heat into the room area in a manner maintaining a desirable operative light element temperature. This is provided by the relatively high heat conductivity of the portion 66 and the surface area. The component 64 is formed from aluminium material.

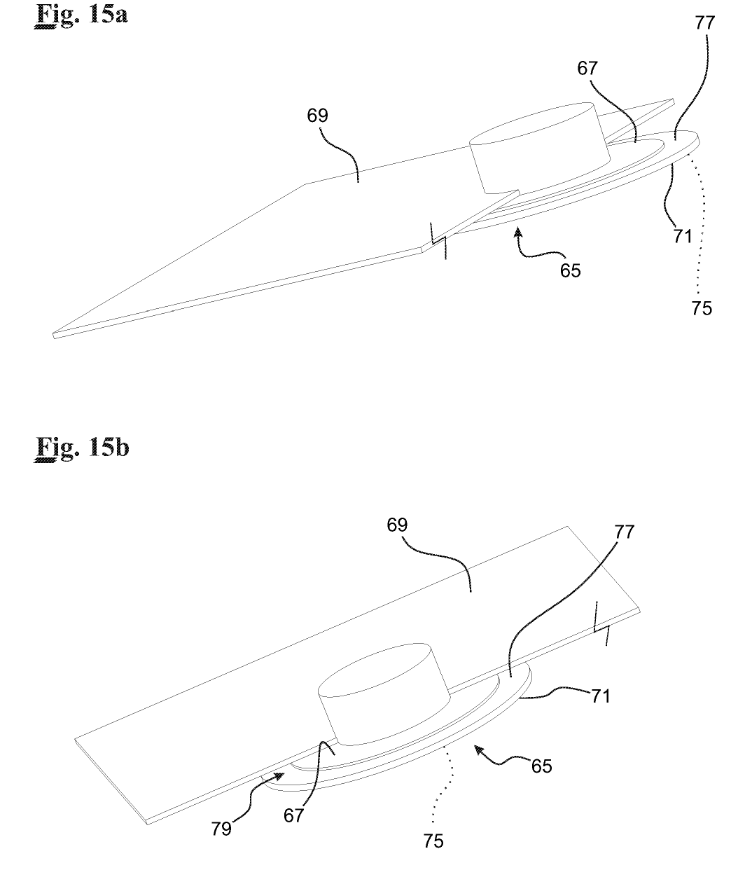

Referring to FIGS. 15a and 15b there is shown a downlight 65 according to a further preferred embodiment of the present invention. The downlight 65 has a first portion for bearing against the downward face of a piece of plasterboard 69 (a part thereof being shown) and a second portion 71 for providing a section that has a relatively large surface area for being exposed to cool air. The first portion 67 provides a conductive bridge for desirable contact with the plasterboard 69. The second portion 71 provides both a forward facing surface area 75 and a reward facing surface area 77 for being cooled by air. Conductive adhesive is used to secure the first portion 67 to the plasterboard 69. A gap 79 is provided between the plasterboard 69 and the second portion 71 to allow air flow. Various shapes and arrangements could be provided. Depending on the circumstances it may be that the first portion 67 does not conduct with the second portion 71 providing the necessary heat dissipation.

In embodiments an extra-large circular or square face with plain or detailed designs around the LED fitting may be provided. With the face in the living area this would serve to dissipate heat, without any substantial dissipation in the roof under the insulation at all.

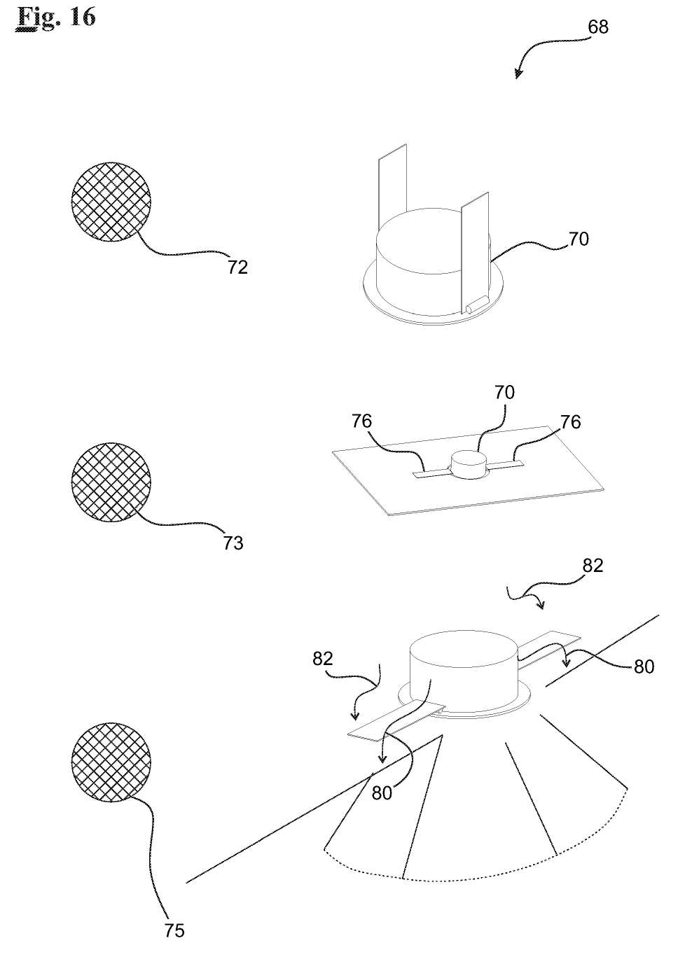

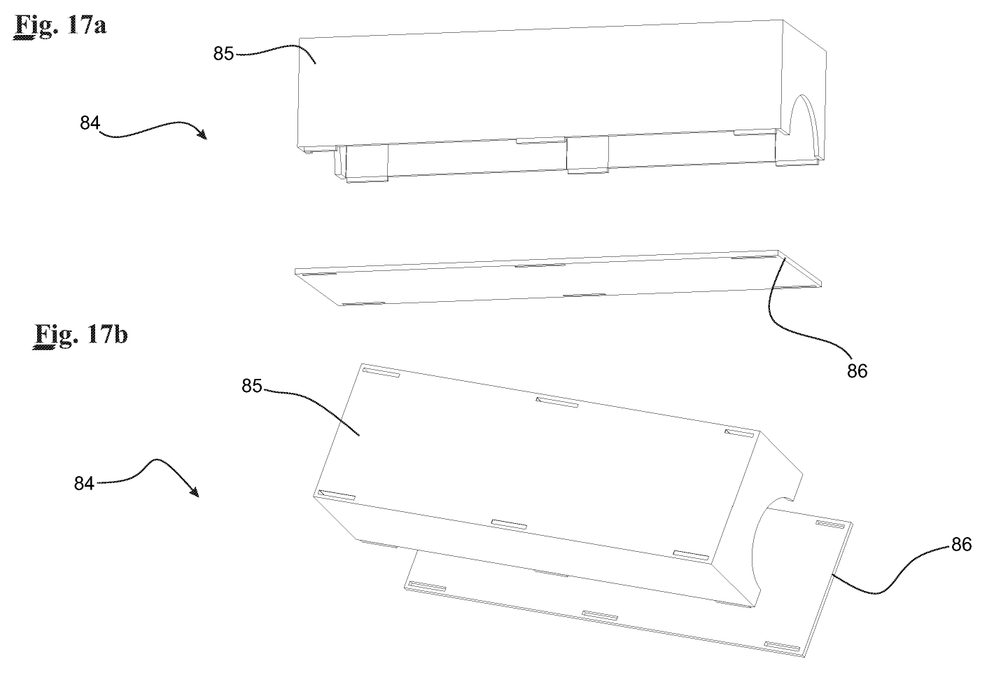

Referring to FIG. 16 there is shown a method 68 according to a further preferred embodiment. The method 68 advantageously controls the elevated temperature of a downlight 70. At block 72 the downlight is placed in a compact condition. At block 73 the downlight 70 is in inserted into a hole in plasterboard and released to engage the plasterboard with two highly conductive arms 76. At block 78, during operation, the arms 76 proactively transmit heat away from the downlight 70. The arms 76 contact plasterboard or other ceiling material and dissipate heat in a manner maintaining a desirable operative temperature due to the relatively high heat conductivity of the arms 76 and surface area transmitting heat energy into the room area below. Heat is transmitted to arm 76 as part of conductive pathways 80 and radiation pathways 82.

Referring to FIGS. 17a and 17b, there is shown a down-light system transformer holder 84 according to another preferred embodiment. The receptacle 84 includes a base 86 that is made from relatively high heat-conductivity material. The base 86 is arranged to transmit heat energy, from a transformer placed in the transformer holder 84, into plasterboard or other ceiling material to dissipate the heat energy. A cover is 85 is provided for mating with the base 86 with the transformer held therebetween.

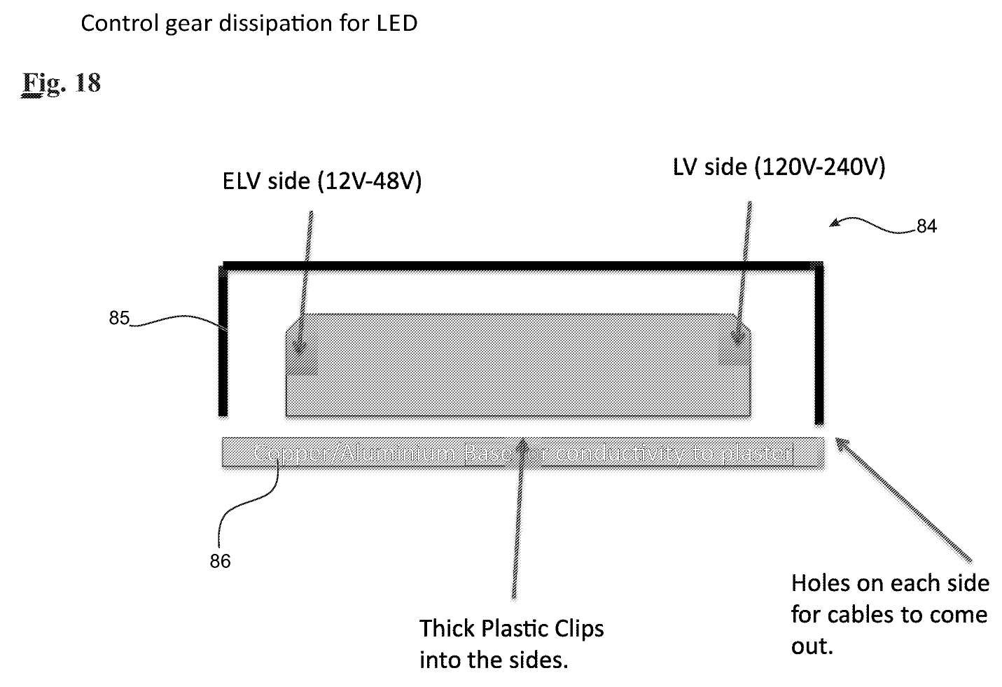

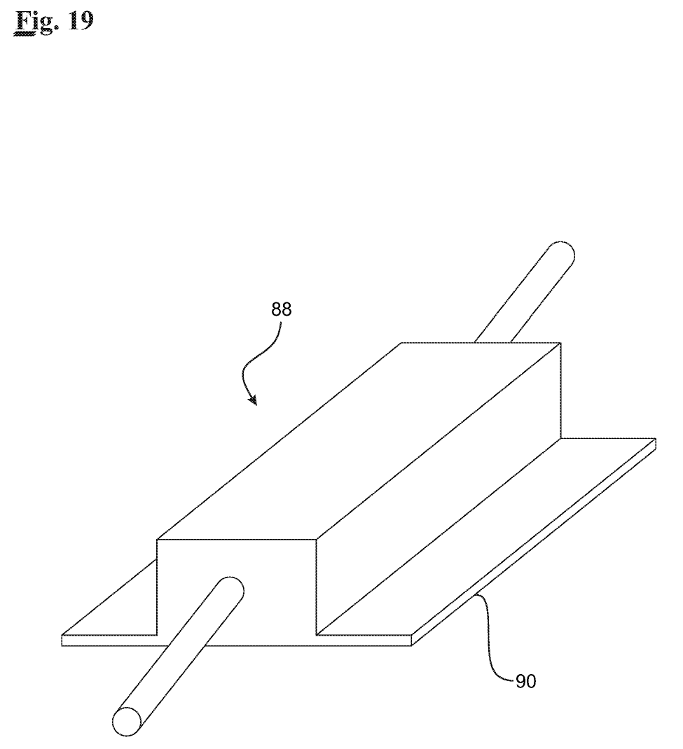

In this embodiment there is no light, but rather a transformer. The base 86 is formed from highly conductive material (e.g. copper/aluminium material). The holder 84 may include clips on the base for holding the transformer in position. FIG. 18 provides a further illustration. The holder may advantageously allow the transformer to be installed safely under insulation without presenting a fire risk. Various holes may be provided for cabling.

FIG. 19 shows a transformer 88 having a conductive base 90. Rather than being housed in a holder, the transformer 88 itself has been provided with a base that readily conducts heat into the plasterboard. This allows the transformer 88 itself to conduct heat into the plasterboard and be located beneath the insulation. The ability to cover a transformer of an LED downlight system with insulation is considered to be advantageous. The base may have a matt surface to assist with heat transfer. Preferably a conductive paste is used for a good conductivity between the base and the plasterboard.

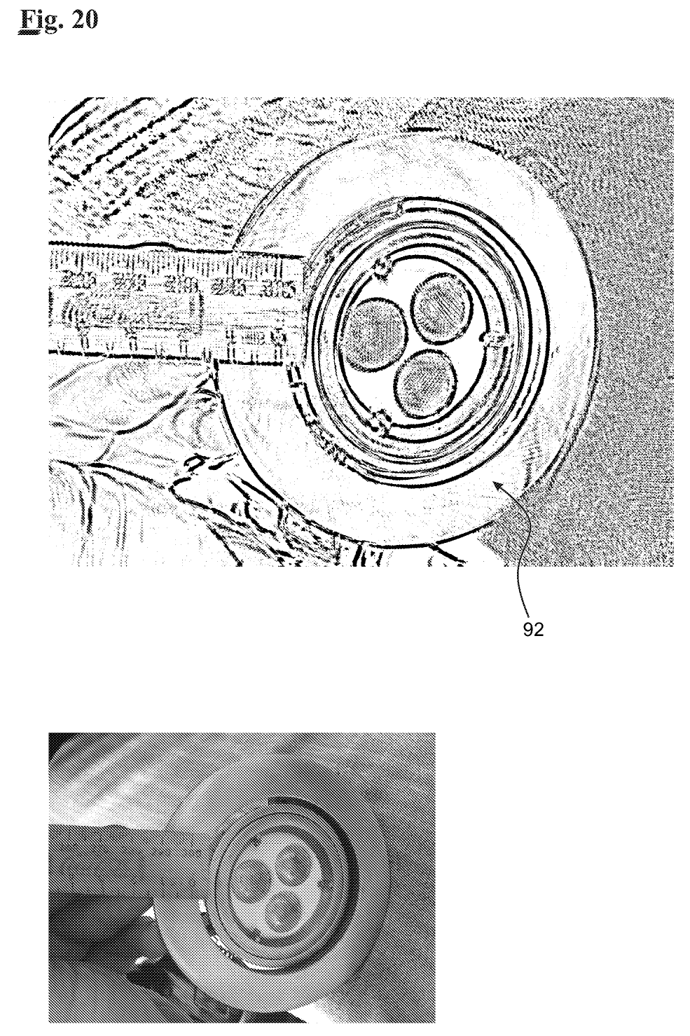

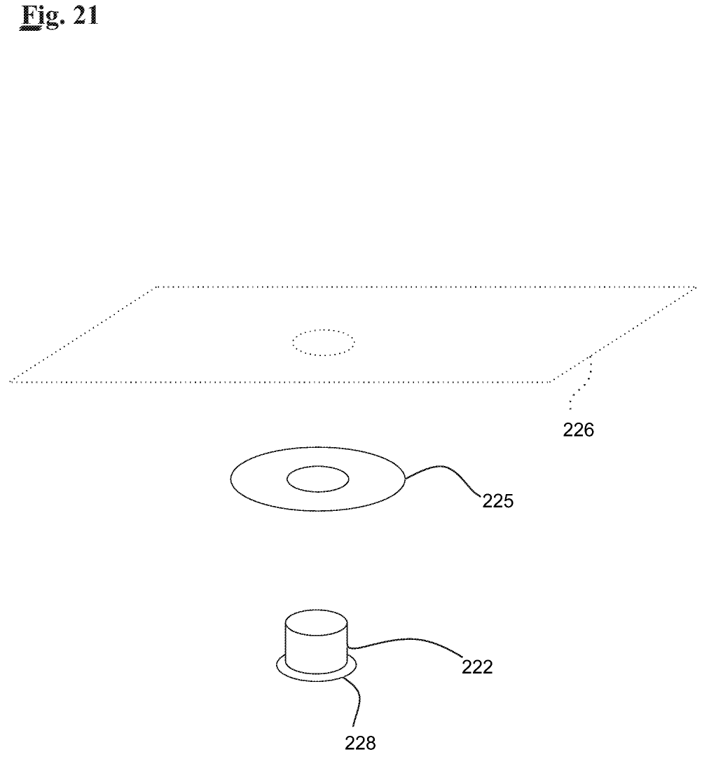

FIG. 20 shows a LED light fitting according to an embodiment. The diameter is about 90 mm and the rim about 1.5 cm. Preferably the surface area is near or greater than 30 cm̂2. The Applicant considers that a 20 cm2 or more should be applied in addition to the current ridge on led Downlights (1.5 cm), built into the downlight. The extract surface area as shown in FIG. 20 conducts onto the body directly and goes out further than the ridge that makes up a downlight. This piece could be slightly spaced by a seal so that it is not in contact with the plasterboard to enable additional surface area behind the fitting but inside the building envelope towards the plaster for dissipation of heat. The system provide a larger surface area for radiant dissipation of heat under an insulative barrier.

FIG. 21 shows a retrofit arrangement in which an LED fitting 222 is retrofitted by insertion into a metal plate 224 located between the LED fitting 222 and the plasterboard 226. The conventional rim 228 providing the face of the LED bears against the plate 224 to provide the heat transfer to the plate 224. The plate 224 is glued with conductive glue other conductive material to the plasterboard. Conductive adhesive material could also be used between the rim 228 and the metal plate 224.

FIGS. 22a to 22d illustrate a transformer holder 230 according to a further preferred embodiment. The transformer holder 230 is provided as a length of spring steel that is configured to firmly press down and hold a transformer 232 to a surface 234. In the embodiment the transformer holder 230 includes a mount portion 236 for being fixed to a structure such as a beam. A number of screws may extend through the mount portion 236 to hold the transformer holder 230 to the beam.

The transformer holder 230 is configured to further bias the transformer 232 towards the surface 234 to assist with ensuring desirable conductivity.

The transformer holder 230 includes a contact portion 238 for bearing against the upper portion of the transformer 232. In this embodiment the contact portion 238l comprises a bow portion. The mount portion 236 comprise a flange that extends from the bow portion in the same direction of the concavity outwards. A number of mounting holes may be provided in the mount portion 236 for receiving screws.

The transformer, in embodiments, can be covered in insulation, as opposed to needing to be strung from rafters clear of insulation. There is quick and easy installation of transformers for electricians.

As with the other embodiments the system is considered to provide insulation consistency as well as to reduce hot spots under transformers. In the majority of LED failure cases, it's the transformers which are failing prior to the LED failing. This is considered to provide an improvement that improves installation time while also improving the reliability of the LED system.

Approximately a 20 mm gap is provided for the transformer 232 beneath the holder 230. The holder 230 is approximately 30 mm tall, 50 mm deep and 120 mm wide.

In this manner there is provided a mount 230 for assisting with controlling the elevated temperature of a transformer 232. The mount 230 includes a biasing portion 238 for forcing the transformer 232 towards plasterboard 234 or other ceiling material. The biasing portion 238 assists with transmitting heat away from the transformer 232 by ensuring contact with the plasterboard 234 or other ceiling material. The mount 230 is formed from spring steel and includes a portion 236 for fixing the mount to a beam/surface. The mount 230 provides a method of forcing the transformer 232 toward plasterboard 234 or other ceiling material to assist with transmitting heat away from the transformer by ensuring contact.

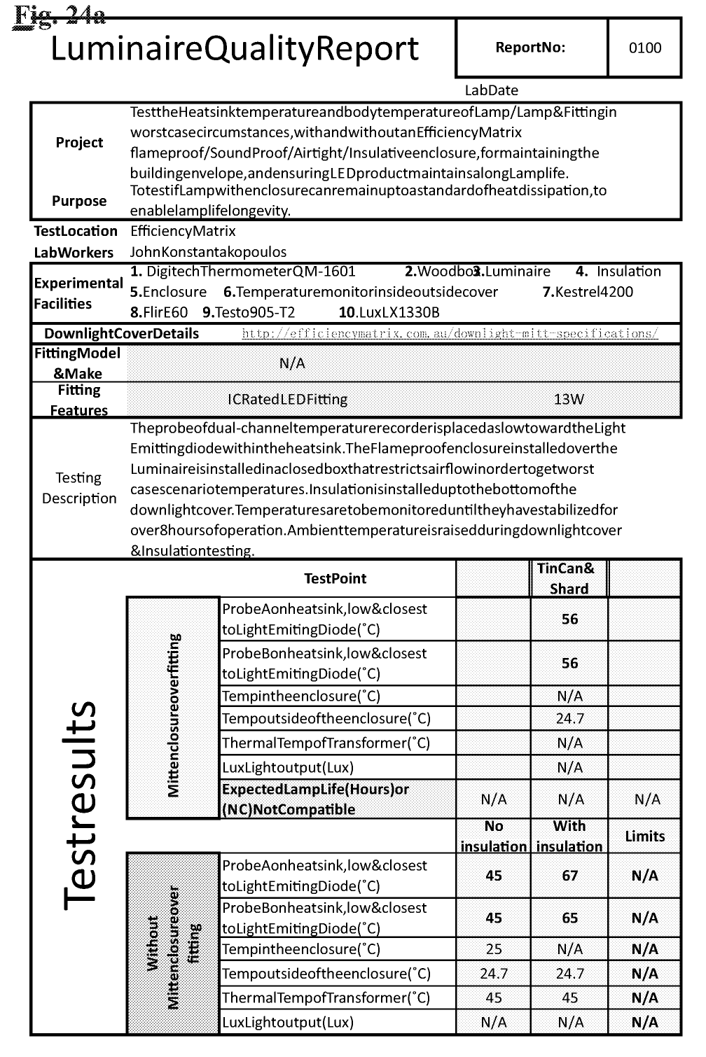

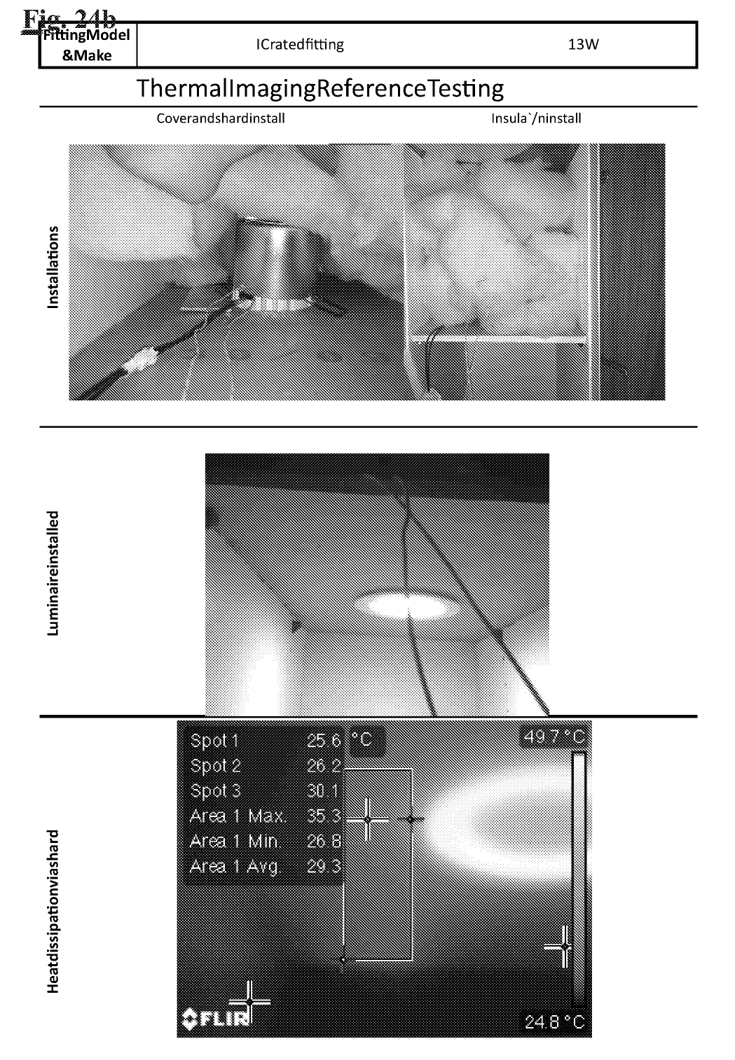

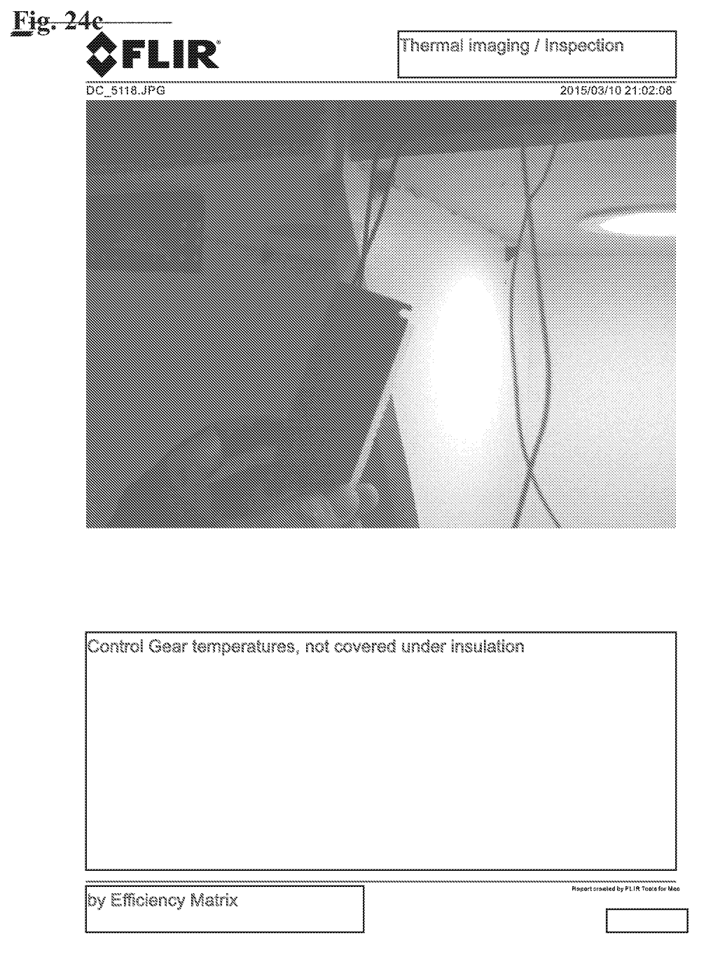

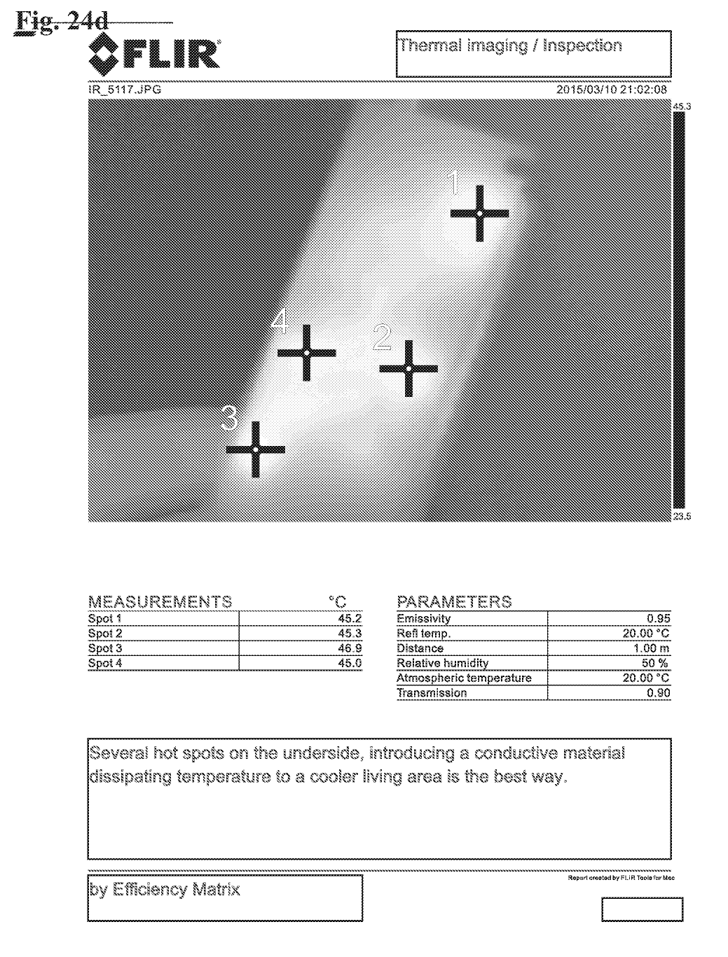

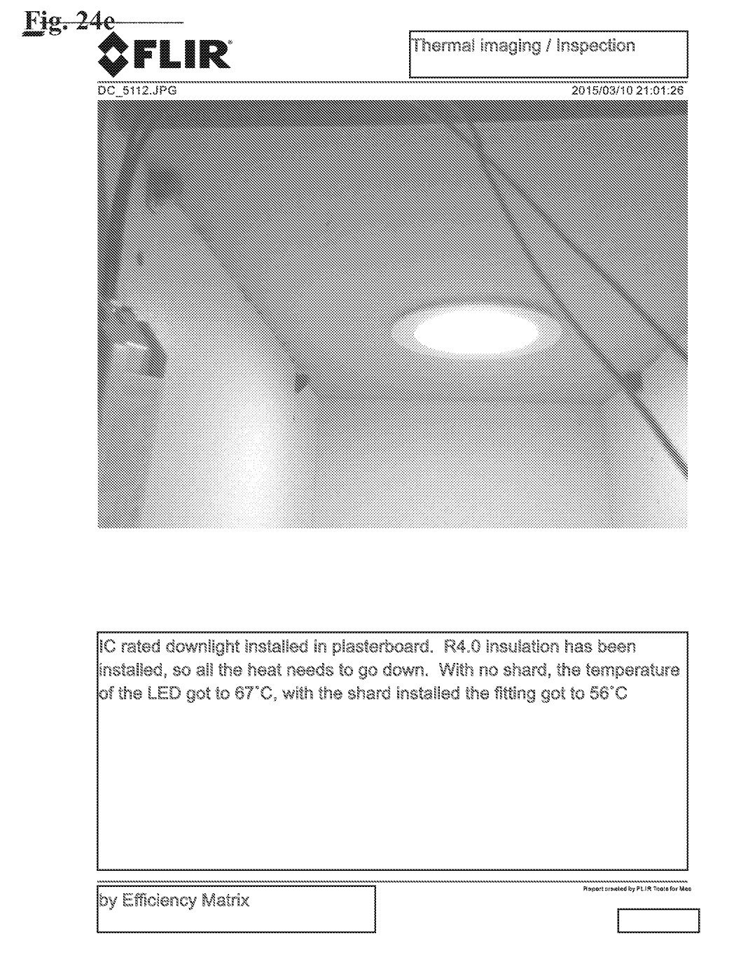

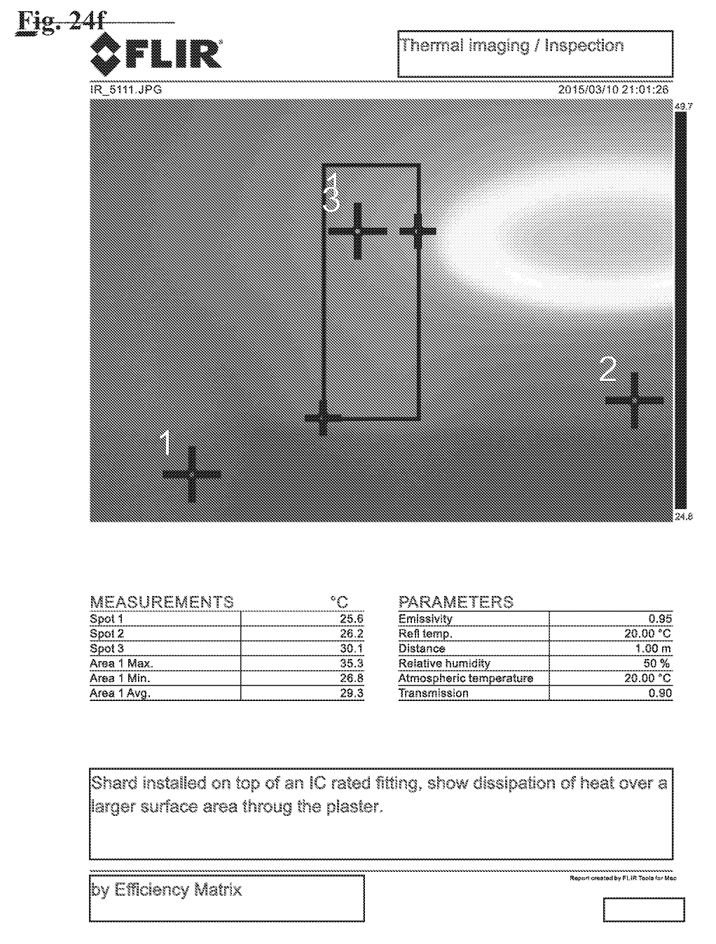

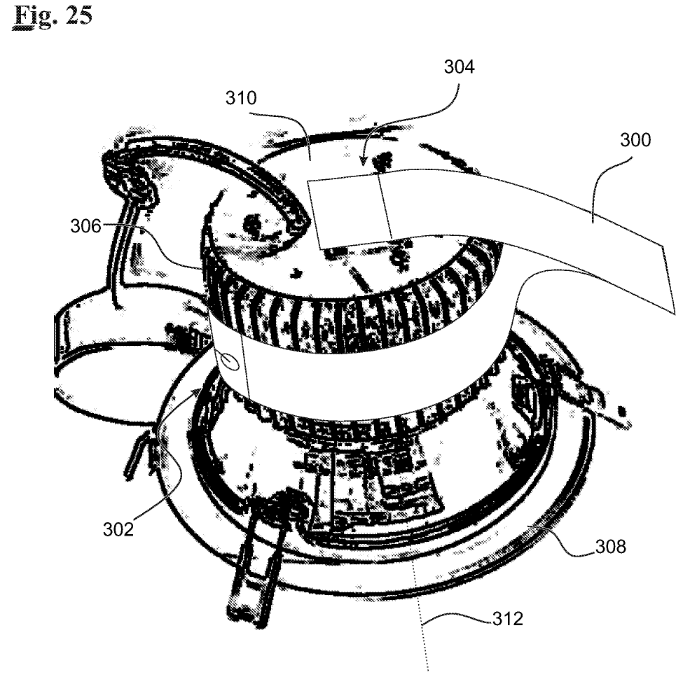

Various arrangements of preferred embodiments are possible. Various reports and papers are provided in FIGS. 23 and 24 and below. Among other things these reports indicate a temperature drop of about 20 degrees for a 13 W IC Rated LED Fitting without a cover. The Applicant considers that initial results are promising for both LEDS lights and control gear as used in downlight LED systems.

FIG. 24b shows some thermal imagining reference testing.

FIG. 24c shows control gear not covered by insulation.

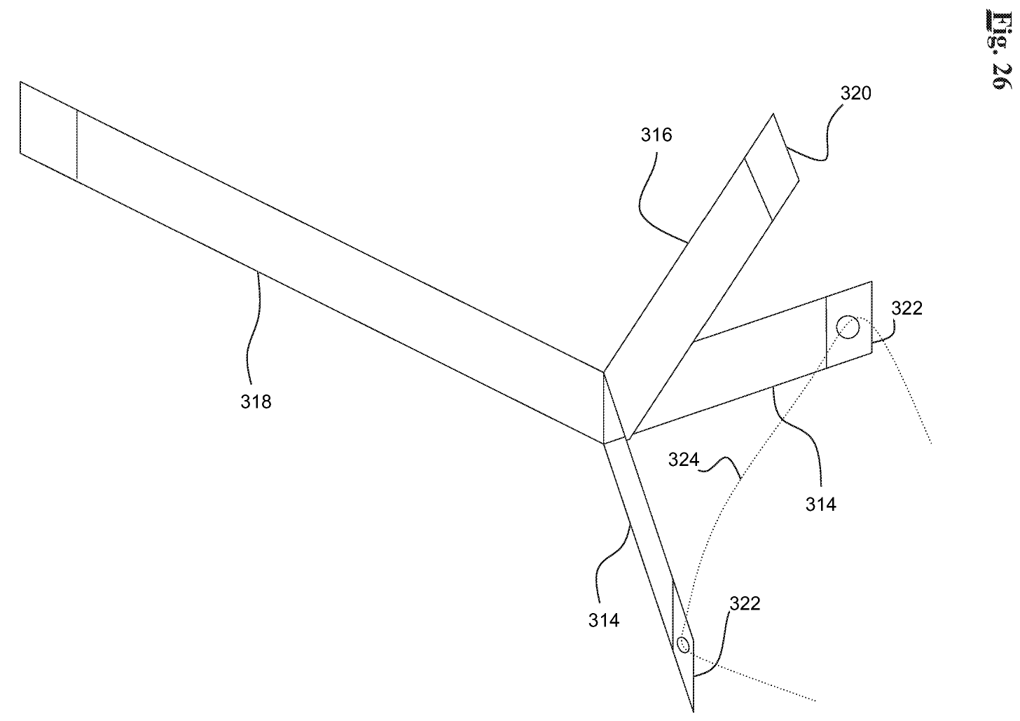

Referring to FIG. 25 there is shown a down-light system component 300 according to a further preferred embodiment of the present invention. The down light system component 300 includes a first portion 302 and a second portion 304 made from relatively high heat-conductivity material. The first portion 302 comprises two lengths able to extend around the body 306 of a downlight 308. The second portion 304 is provided for contacting the top 310 of the downlight 308. The first portion 302 and the second portion 304 are configured to conduct heat away from the downlight 308 to a heat sink (not shown) in a manner maintaining a desirable operative temperature of the downlight.

The first portion 302 extends around the body 306 of the downlight 308 around the longitudinal axis 312. The second portion 304 is arranged to extend above the first portion 302 as shown in FIG. 24.

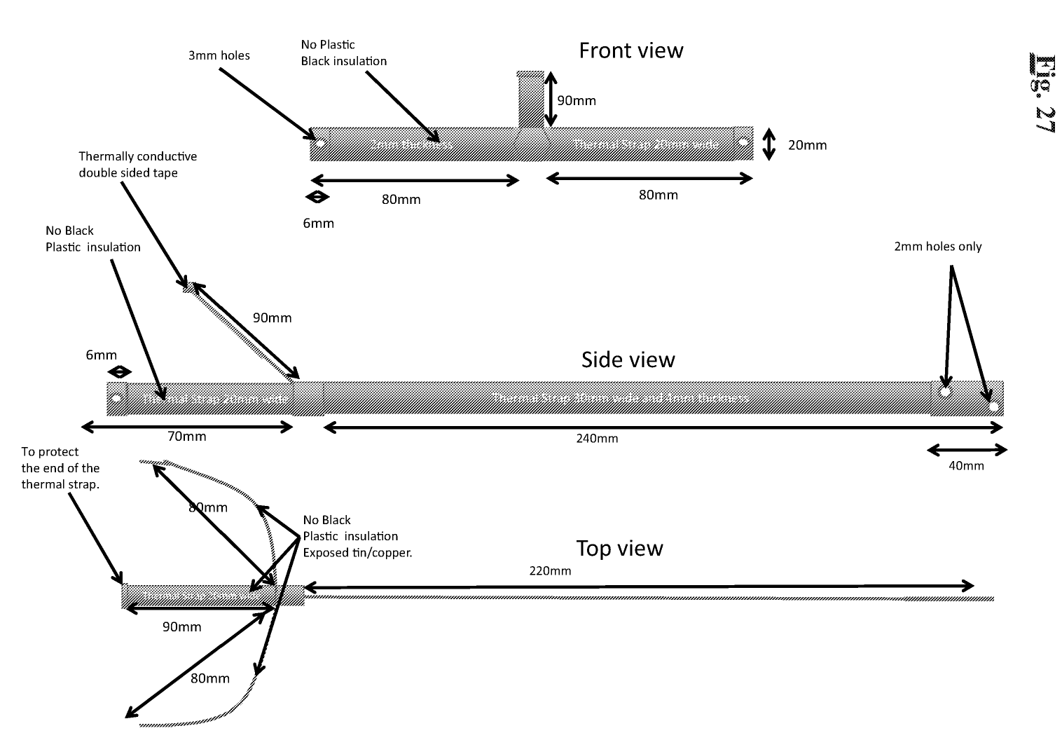

FIG. 26 provides a schematic illustration. The first portion 302 comprises two arms 314 and the second portion 304 comprises a further arm 316. Each of the arms 314, 316 extend from a conductive length 318. The further arm 316 includes a solid metal tab 320 for being glued to the top 310 of the downlight 308 using a conductive glue.

The two arms 314 include respective ends 322 that are configured to be connected together using a connecting element in the form of a contracting length 324 between the ends 322. As will be described in further detail below the contracting length may be provided by a temperature rated string having a releasable clasp. A temperature rated string is presently preferred for reasons of strength and resistance to heat. Other forms of cord may also be used.

Thus the first portion 302 comprises two extending portions configured to be secured together in a manner where each extending portion extends around the body 306 of the downlight 308. It is to be appreciated that other embodiments may include a single arm 314 that wraps partially or fully around the body 306.

Various preferred lengths are illustrated in FIGS. 26a to 26c. An arm length 314, 316 of 70 mm is presently preferred in the current embodiment. Other lengths are of course possible. The conductive length 318 terminates in a solid tab having a number of screw holes for securing to a heat sink.

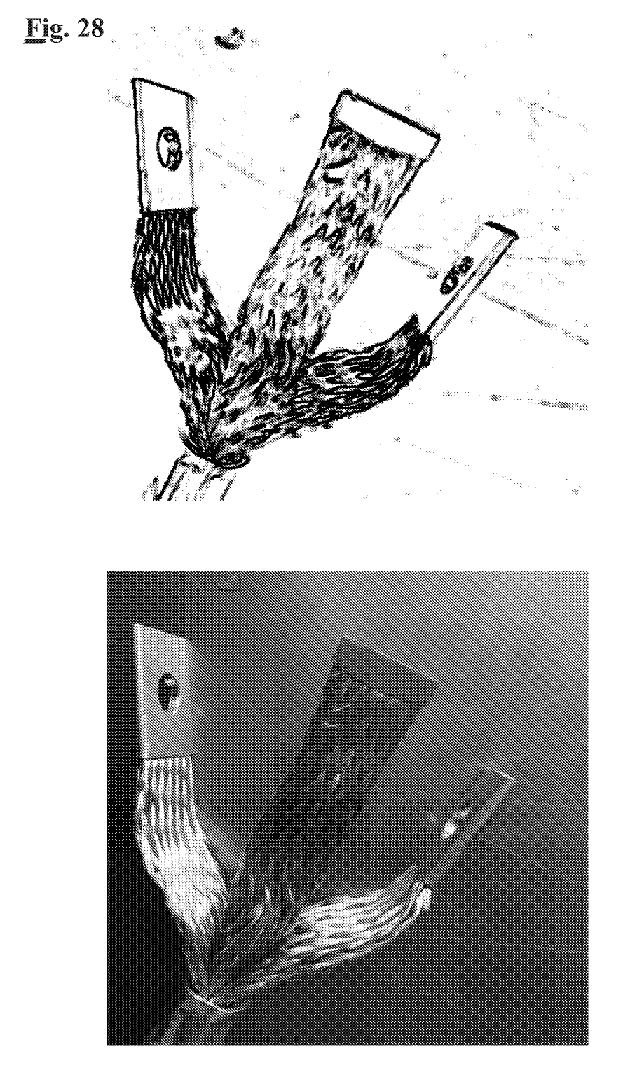

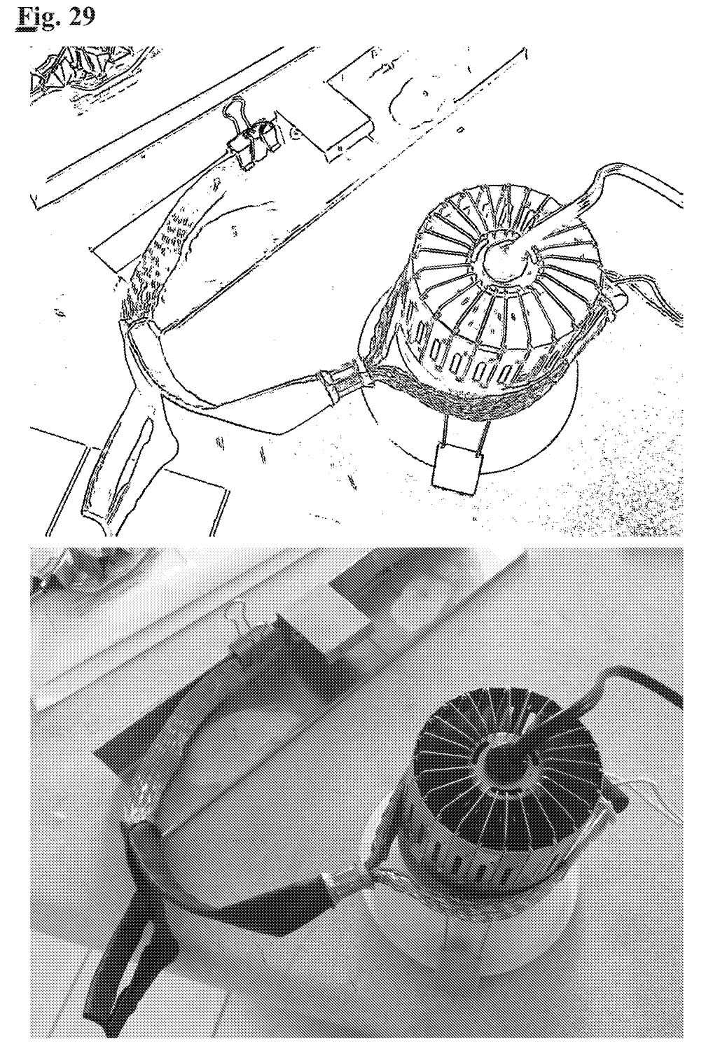

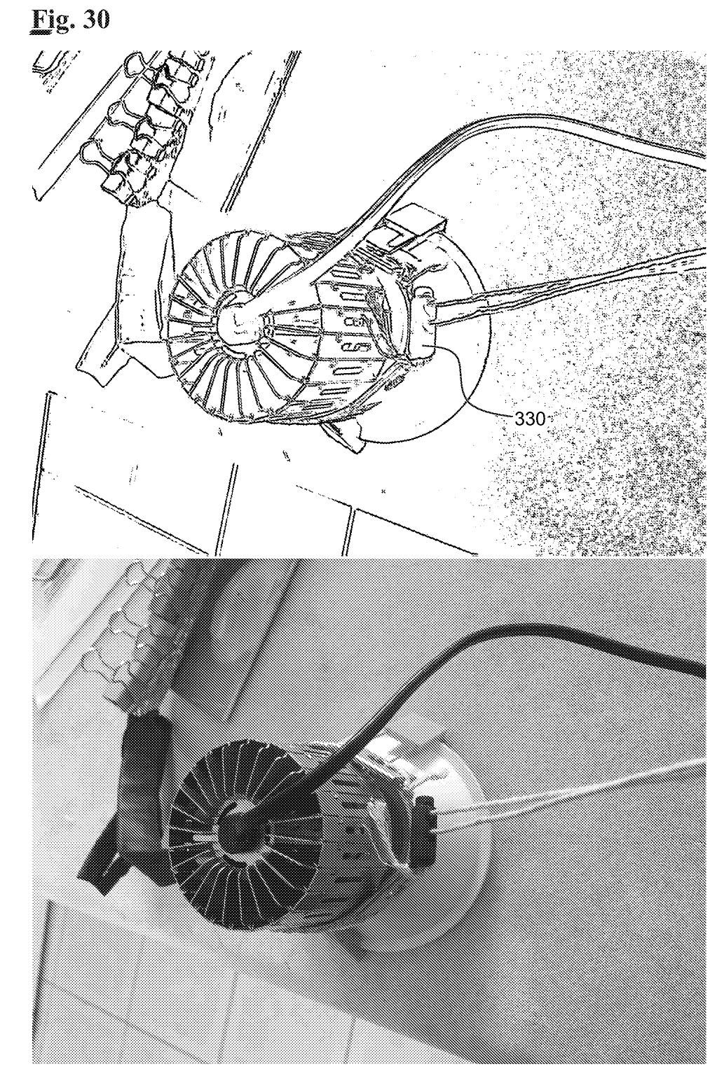

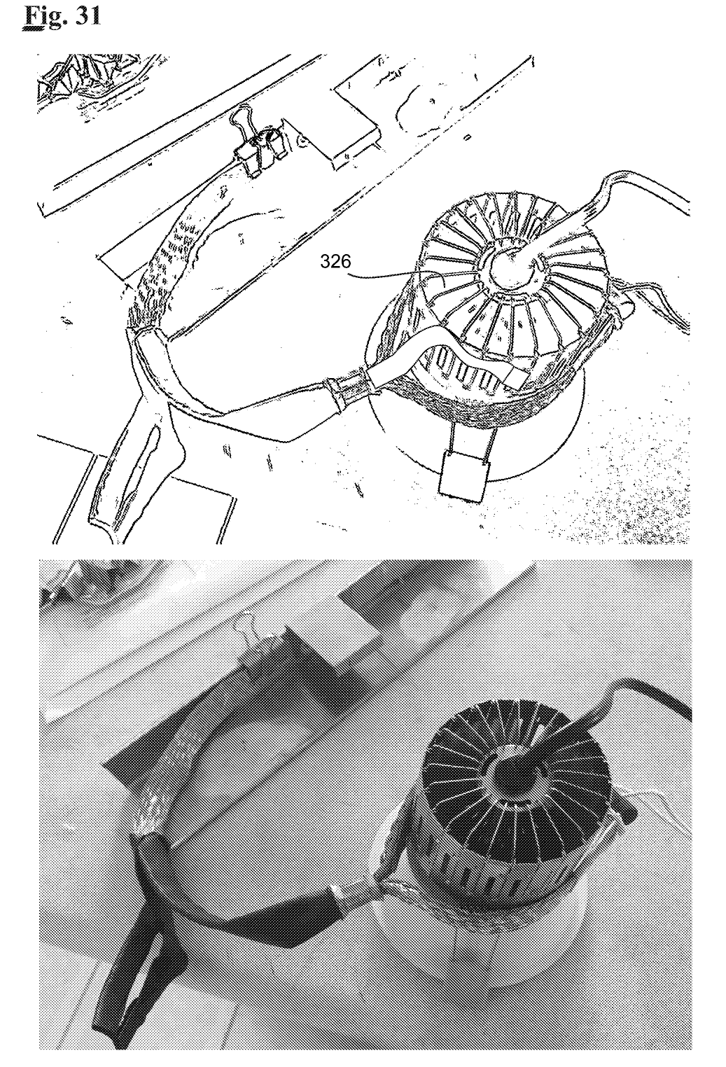

FIG. 27 illustrates the flexibility of the arms 314, 316. The arms 314, 316 may comprise braided metal wire. An example of the flexibility of the wire is illustrated in FIGS. 28 and 29. This allows wrapping around the body of the downlight and positioning on top of the downlight.

FIGS. 28 and 29 illustrate the use of a draw string arrangement in which a flexible cord extends through a releasable clasp 330 that tightens or loosens the connection between the arms 314. The use of flexible temperature rated string is preferred.

FIG. 30 illustrates a possible further arrangement. The second portion can be positioned accordingly.

Thus there has been consider to have been provided a downlight system component comprising: a length of heat conductive material having a first end for a downlight and a second end for a heat sink; the first end comprising at least one portion for extending around the body of a downlight; and a further portion for contacting the top of the downlight; the first end for conducting heat away from the downlight to the heat sink in a manner maintaining a desirable operative temperature of the downlight.

A third portion provides a heat sink length from which the first portion and the second portion extend. The second portion comprises an element having an end adapted to be glued to the top of the downlight to conduct more heat away from the downlight than with the first portion alone.

The arrangement preferably provides between a 10 to 20 degree temperature drop when under insulation compared to when the arrangement is not employed. In this manner a desirably lower operative temperature is maintained while operating under insulation.

Two arrangements may be used on a single LED light to provide a further temperature drop.

In the embodiments thermal glue or paste is used to provide a good thermal connection between the body 306 and the first portion 302. Thermal paste is presently preferred as the first portions 302 is easier to remove.

Thermal glue is used to secure the second portion 304. Various arrangements are of course possible.

In connection with several embodiments there is provided an advantageous solution for recessed lighting. Covers can be a highly conductive material (Copper, Aluminium ceramic or graphite) (which may be coloured in a conductive/radiative colour) to allow dissipation of heat downward through plasterboard. Creation of another holder specifically designed for control gear to exist under insulation also in a similar fashion to enable heat dissipation downwards into the building envelope through plasterboard.

By utilising highly conductive materials with a significant surface area this allows the fitting to be effectively connected to a much cooler area. Current fittings which are advertised as being able to be covered, raise in temperature significantly, and this raise in temperature is considered to present a huge potential of reducing the LED lamp life possibly by 3 to 4 fold. Embodiments may also allow fittings which are not coverable with insulation, to be covered with insulation. The design can also be implemented onto new LED designs, where a heat sink flips out once the fitting has been installed as discussed.

Plaster temperature when it is insulated, usually stays at around 25° C. and has a very low R-value of around 0.05. Due to most downlights having to be covered, plaster board provides a cool temperature. Roof areas in Australia during summer can go from 35° C. to 70° C.

Using conductive materials to connect the thermal dissipation to the living area and over insulating these types of fittings is actually the way to go.

The overall impacts of various solutions include longer lamp life for LED lighting/and control gear. Other impacts that may be provided include a consistent R-value by assisting with providing a continuous insulation cover (across a ceiling space or wall cavity to enable effective insulation performance).

With the use of both conduction and radiation, an LED/Control gear can be provide that drives the LED to dissipate its temperature into a cooler living area via connectivity of a conductive/radiative downlight cover that sits on top of the plaster with a designed surface area connectivity to that part of the air tight building envelope. Plasterboard has a relatively poor R-value so radiating heat through it with a decent conductive material can be quite effective, when insulation has been installed above.

Thermal straps could be utilised such as http://www.techapps.com/thermalstram, linking to the LED using a conductive glue or weight.

Notably, the design of a conductive material dissipating heat underneath the plaster can include many designs to create dissipation on both sides of a conductive material in the living area and add design detail to the fitting. Some fittings today have a rubber seal for air tightness which attaches to the plasterboard. A conductive paste, that is used with computer heat sinks, may be used here. For fittings with a rubber seal, this may need to be removed, and added to the heat sink.

In addition, various heat sinks may be used on top of the luminaire, dissipating heat directly under insulation. For flatter luminaries a square and weighted attachment could be combined with a flexible conductive material using a thermal strap design, in conjunction with a conductive paste, or a cover that would absorb radiated heat from the luminaire.

Both conventional LED and OLED lighting systems are envisaged. Wattages from low to 20 W, 20 W to 40 W and 40 W and above are envisaged. The advantages of and applicability would be apparent from a reading of the specification as a whole.

Among other advantages preferred systems herein described are considered to advantageously provide for: (i) quick and easy install of control gear under insulation; (ii) more efficient heat dissipation to enable longer life control gear; and (iii) more consistent insulation around recessed lighting.

Various ranges and sizes are described in the specification as a whole. Various sizes and approaches could be adopted in providing embodiments of the present invention.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1. A down-light system component comprising: a portion that is made from relatively high heat-conductivity material; the portion for conducting heat away from a light source to plasterboard or other ceiling material; the portion being configured to dissipate heat in a manner maintaining a desirable operative temperature of the light source.

2. A down-light system component as claimed in claim 1 wherein the portion is for conducting heat to the plasterboard or other ceiling material, above a room area, to cause the plasterboard or other ceiling material to act as a heat sink for transmission into the room area below.

3. A downlight system component as claimed in claim 1 wherein the surface area of the portion is at least 30 cm̂2.

4. A downlight system component as claimed in claim 1, 2 or 3 claim 1 wherein the material comprises predominantly copper, graphite or aluminium aluminum material and the surface area is at least 40 cm̂2.

5. A downlight system component as claimed in claim 1 wherein the surface area of the portion is at least 20 cm̂2.

6. A downlight system component as claimed in claim 1 wherein the material comprises predominantly copper, graphite or aluminum material to provide relatively high heat conductivity and the surface area is between 30 to 50 cm̂2.

7. A down light system component as claimed in claim 1 wherein the surface area is sized for a LED-type light having a power consumption of at least 40 Watts.

8. (canceled)

9. A downlight system component as claimed in claim 1 wherein the downlight system component includes at least one elongate planar portion having a relatively large planar face for contacting and extending above the plasterboard or other ceiling material away from the light source along the plasterboard or other ceiling material.

10. A downlight system component as claimed in claim 9 wherein the or each at least one planar portion is able to be inserted through a hole sized for receiving a downlight of the downlight system, enabling the downlight system component to be installed from below the plasterboard or other ceiling material.

11. A downlight component as claimed in claim 1 wherein the downlight system component includes a head portion and a flexible tether, both of relatively high heat conductivity; the flexible tether having one end for being wrapped around the body of a lighting element and extending to the head portion for transmitting heat thereto, the head portion for contacting the plasterboard or other ceiling material.

12. A downlight component as claimed in claim 1 including at least one planar element connected to a rim surrounding the face of the lighting element; the at least one planar element having a surface area of at least 15 cm̂2; the at least one planar element being moveable between an upright condition and a substantially horizontal condition for contacting and extending above the plasterboard or other ceiling material.

13. A downlight component as in claimed in claim 1 wherein the portion comprises a base portion for contacting the plasterboard or other ceiling material from above and transmitting heat thereto; and an extension portion for extending around an upper end of the light source and conducting heat away from the light source to the base portion.

14. A downlight component as claimed in claim 13 wherein the extension portion comprises a flexible tether having two ends in the vicinity of the plasterboard or other ceiling material; the flexible tether for extending over the rear of the light source to the other end.

15. A downlight component as claimed in claim 14 wherein the extension portion further includes a relatively high heat conductivity cover for receiving the light source.

16. A downlight component as claimed in claim 15 wherein the extension portion is cone-shaped for fitting into a downlight cover.

17. A downlight component as claimed in claim 16 wherein the extension portion includes a slit along its length on one side for allowing cabling to access the light element.

18. A downlight component as claimed in claim 1 wherein the component provides and IC or IC-F rated light fitting that can be fully covered with insulation.

19-21. (canceled)

22. A down-light system component comprising: a portion that is made from relatively high heat-conductivity material; the portion for contacting plasterboard or other ceiling material to dissipate heat in a manner maintaining a desirable operative light element temperature due to the relatively high heat conductivity of the portion and surface area transmitting heat into the plasterboard or other ceiling material for transmission into the room area below.

23. A method of controlling the elevated temperature of a downlight or transformer comprising proactively transmitting heat away from a lighting element of the downlight or transformer by providing a portion that is made from relatively high heat-conductivity material; the portion for contacting plasterboard or other ceiling material to dissipate heat in a manner maintaining a desirable operative temperature due to the relatively high heat conductivity of the portion and surface area transmitting heat into the room area below.

24-36. (canceled)
